(19) United States
(12) Patent Application Publication
(10) Pub. No.: US 2025/0077499 A1
(43) Pub. Date: Mar. 6, 2025

(54) DATA STRUCTURE MARSHALLING UNIT

(71) Applicants: Arm Limited, Cambridge (GB); Barcelona Supercomputing Center - Centro Nacional de Supercomputación, Barcelona (ES)

(72) Inventors: Marco SIRACUSA, Barcelona (ES); Joshua RANDALL, Austin, TX (US); Douglas James JOSEPH, Leander, TX (US); Miquel MORETÓ PLANAS, Sant Just Desvern (ES); Adrià ARMEJACH SANOSA, Vilafranca del Penedès (ES)

(21) Appl. No.: 18/240,632

(22) Filed: Aug. 31, 2023

(51) Int. Cl. G06F 16/22

(52) U.S. Cl. CPC G06F 16/2272

(57) ABSTRACT

A data structure marshalling unit for a processor comprises data structure traversal circuitry to perform data structure traversal processing according to a dataflow architecture. The data structure traversal circuitry comprises two or more layers of traversal circuit units, each layer comprising two or more parallel lanes of traversal circuit units. Each traversal circuit unit triggers loading, according to a programmable iteration range, of at least one stream of elements of at least one data structure from data storage circuitry. For at least one programmable setting for the data structure traversal circuitry, the programmable iteration range for a given traversal circuit unit in a downstream layer is dependent on one or more elements of the at least one stream of elements loaded by at least one traversal circuit unit in an upstream layer. Output interface circuitry outputs to the data storage circuitry at least one vector of elements loaded by respective traversal circuit units in a given active layer of the data structure traversal circuitry.

### BACKGROUND

### Technical Field

The present technique relates to the field of data processing.

### Technical Background

Some processing workloads may require access to a data structure stored in memory for which address access patterns are highly non-linear because elements loaded from one part of the structure may be used to identify which parts of another part of the structure are to be accessed. Such workloads can have poor performance when implemented in software executing on a general purpose processor.

### SUMMARY

At least some examples of the present technique provide a data structure marshalling unit for a processor, the data structure marshalling unit comprising:
data structure traversal circuitry to perform data structure traversal processing according to a dataflow architecture;
   the data structure traversal circuitry comprising a plurality of layers of traversal circuit units, each layer comprising a plurality of lanes of traversal circuit units configured to operate in parallel;
   each traversal circuit unit configured to trigger loading, according to a programmable iteration range, of at least one stream of elements of at least one data structure from data storage circuitry;
   where for at least one programmable setting for the data structure traversal circuitry, the programmable iteration range for a given traversal circuit unit in a downstream layer is dependent on one or more elements of the at least one stream of elements loaded by at least one traversal circuit unit in an upstream layer of the data structure traversal circuitry; and
output interface circuitry to output to the data storage circuitry at least one vector of elements loaded by respective traversal circuit units in a given active layer of the data structure traversal circuitry.

At least some examples provide an apparatus comprising: the data structure marshalling unit described above; and the processor.

At least some examples provide a system comprising: the data structure marshalling unit described above, implemented in at least one packaged chip; at least one system component; and a board, wherein the at least one packaged chip and the at least one system component are assembled on the board.

At least some examples provide a chip-containing product comprising the system described above, assembled on a further board with at least one other product component.

At least some examples provide a non-transitory computer-readable medium to store computer-readable code for fabrication of a data structure marshalling unit for a processor, the data structure marshalling unit comprising:
data structure traversal circuitry to perform data structure traversal processing according to a dataflow architecture;
   the data structure traversal circuitry comprising a plurality of layers of traversal circuit units, each layer comprising a plurality of lanes of traversal circuit units configured to operate in parallel;
   each traversal circuit unit configured to trigger loading, according to a programmable iteration range, of at least one stream of elements of at least one data structure fiber from data storage circuitry;
   where for at least one programmable setting for the data structure traversal circuitry, the programmable iteration range for a given traversal circuit unit in a downstream layer is dependent on one or more elements of the at least one stream of elements loaded by a traversal circuit unit in an upstream layer of the data structure traversal circuitry; and
output interface circuitry to output to the data storage circuitry at least one vector of elements loaded by respective traversal circuit units in a given active layer of the data structure traversal circuitry.

At least some examples provide a method comprising:
performing data structure traversal processing using data structure traversal circuitry of a data structure marshalling unit for a processor, the data structure traversal circuitry performing the data structure traversal processing according to a dataflow architecture;
   the data structure traversal circuitry comprising a plurality of layers of traversal circuit units, each layer comprising a plurality of lanes of traversal circuit units configured to operate in parallel;
   each traversal circuit unit configured to trigger loading, according to a programmable iteration range, of at least one stream of elements of at least one data structure fiber from data storage circuitry;
   where for at least one programmable setting for the data structure traversal circuitry, the programmable iteration range for a given traversal circuit unit in a downstream layer is dependent on one or more elements of the at least one stream of elements loaded by a traversal circuit unit in an upstream layer of the data structure traversal circuitry; and
outputting to the data storage circuitry at least one vector of elements loaded by respective traversal circuit units in a given active layer of the data structure traversal circuitry.

Further aspects, features and advantages of the present technique will be apparent from the following description of examples, which is to be read in conjunction with the accompanying drawings.

### BRIEF DESCRIPTION OF THE DRAWINGS

FIG. 1 an example of a data processing apparatus comprising a data structure marshalling unit;

FIG. 2 illustrates an example of various sparse tensor formats;

FIG. 3 illustrates disjunctive and conjunctive merging of tensor fibers;

FIG. 4 illustrates analysis of rates of frontend and backend stalls for various sparse tensor processing workloads;

FIG. 5 illustrates an example of a data structure marshalling unit and its interaction with a processor and data storage circuitry;

FIG. 6 illustrates an example of configuring traversal circuit units for a particular data structure marshalling operation;

FIG. 7 illustrates an example of how different sparse tensor algebra kernels can be mapped to the data structure marshalling unit using configuration commands;

FIG. 8 illustrates steps performed by the processor;

FIG. 9 illustrates steps performed by the data structure marshalling unit;

FIG. 10 illustrates steps performed by a traversal circuit unit of the data structure marshalling unit;

FIG. 11 illustrates steps performed for controlling merging;

FIG. 12 illustrates examples of controlling different types of merging;

FIGS. 13A to 13G shows a worked example of operation of the traversal circuit units of the data structure marshalling unit;

FIG. 14 illustrates a matrix addition example to illustrate disjunctive merging;

FIGS. 15A to 15D show a worked example illustrating generation of merging predicates and control of inter-layer propagation of elements, for the example of FIG. 14;

FIG. 16 illustrates simulated performance speedup compared to a standard CPU-based implementation of typical tensor processing workloads; and

FIG. 17 illustrates a system and a chip-containing product.

### DESCRIPTION OF EXAMPLES

Some processing workloads may require traversal of data structures stored in memory for which address access patterns are highly non-linear because elements loaded from one part of the structure may be used to identify which parts of another part of the structure are to be accessed. An example of such a data structure can be a sparse tensor for which at least one index structure identifies positions of non-zero elements within the sparse tensor, and the numeric values of those non-zero elements are stored in a densely packed value array. This means that when manipulating the tensor (e.g. adding or multiplying it with another tensor), the values to access in the value array depend on the index values specified by elements loaded from the at least one index structure. Although prefetching techniques may be able to predict some of the addresses accessed in traversal of such data structures, allowing loads to be initiated earlier based on the address predictions to help reduce the number of backend stalls when a processor is unable to execute another instruction because it is still waiting for data to be returned from memory, the inventors recognised that another cause of poor performance of such workloads can be frontend stalls caused by mispredicting an outcome of a branch instruction used to select between alternative subsequent instructions based on whether an item of data loaded from memory meets a given condition. As traversing such data structures can require a significant amount of data-dependent control flow decisions (branches whose taken/not-taken outcome depends on data values loaded from memory), it can be relatively difficult for branch prediction algorithms to predict such control flow with high accuracy, and so conventional techniques using software executing on a general purpose processor can provide poor performance for such workloads.

In the examples below, a data structure marshalling unit for a processor is provided, the data structure marshalling unit comprising data structure traversal circuitry to perform data structure traversal processing according to a dataflow architecture. The data structure traversal circuitry comprises a plurality of layers of traversal circuit units, each layer comprising a plurality of lanes of traversal circuit units configured to operate in parallel. Each traversal circuit unit is configured to trigger loading, according to a programmable iteration range, of at least one stream of elements of at least one data structure from data storage circuitry. For at least one programmable setting for the data structure traversal circuitry, the programmable iteration range for a given traversal circuit unit in a downstream layer is dependent on one or more elements of the at least one stream of elements loaded by at least one traversal circuit unit in an upstream layer of the data structure traversal circuitry. Output interface circuitry is provided to output to the data storage circuitry at least one vector of elements loaded by respective traversal circuit units in a given active layer of the data structure traversal circuitry (the output interface circuitry may in some cases also be capable of outputting scalar elements to the data storage circuitry individually, so scalar output is not excluded, but for at least one setting of the data structure marshalling unit the output circuitry is able to output a vector of elements).

A dataflow architecture is an architecture in which operations have no predefined order in which they are to be performed, but instead the software operations are defined as a set of transformations on input data with a given operation being able to be performed any time that its input data becomes available. Hence, the execution of a given operation is triggered by the availability of the input data to the operation. This contrasts with a traditional control flow architecture which uses the program counter to track the current point of program flow within a predetermined sequence of instructions having a predefined order, for which a given processing operation corresponding to a certain instruction is triggered in response to the program counter reaching the address of that instruction. By using a dataflow architecture for the data structure marshalling units, this eliminates the need to try to predict data-dependent control flow using a branch predictor, eliminating a key source of inefficiency for traversal of sparse tensors or other data structures that involve indirection of memory address computation (where the value of an element loaded from one part of the structure is used to identify the address from which to load another part of the structure).

Also, since the data structure traversal circuitry includes two or more layers of traversal circuit units, which are programmable so that a given traversal circuit unit can be set to load elements of at least one data structure from the data storage circuitry according to a programmable iteration range, and the programmable iteration range for a given traversal circuit unit in a downstream layer can be set to be dependent on elements loaded by at least one traversal circuit unit in an upstream layer of the data structure traversal circuitry, this provides an efficient framework for a processor to offload data structure traversal operations to the data structure marshalling unit. Many software workloads for traversing such data structures can be based on nested loops, where elements loaded from memory in the outer loop may be used to control the address pattern used to determine elements to load from a subsequent part of the structure in multiple iterations of an inner loop. Such operations can be mapped to the layers of traversal circuit units in the data structure traversal circuitry by mapping the iterations of the outer loop to an upstream layer and the iterations of the inner loop to a downstream layer programmed to use elements loaded by the upstream layer to control its iteration range. It has been found through simulation of typical workloads that such an arrangement for the data structure traversal circuitry can greatly accelerate such workloads compared to the performance achieved when executed in software operating on a conventional general purpose processor having a control flow architecture.

Also, each layer of the data structure traversal circuitry comprises a number of parallel lanes of traversal circuit units, which can be programmed to load respective streams of elements from the data storage circuitry according to their respective programmable iteration ranges. The use of parallel lanes means that the elements loaded by respective traversal circuit units in a given active layer of the data structure traversal circuitry can be marshalled into vector operands which can be output the data storage circuitry ready for processing by the processor. The parallel lane structure means that there is much greater flexibility for bringing together vectors of elements which may be loaded from a number of distinct structures in memory (each being traversed with their own programmable iteration range), which would be difficult to achieve with a single lane approach. This can be helpful for enabling greater flexibility in scheduling the parallelisation of accesses to relatively complex multi-dimensional data structures, which can help to improve performance. Marshalling the loaded elements into vector format can also be helpful for assembling the data in a format which can be processed by vector processing units which are present on many modern processors and can be much more efficient at processing the loaded data than a scalar unit. While typical data structure access workloads implemented in software have been relatively inefficient at populating such vectors due to the data-dependent control flow problem, by accelerating the traversal using the data structure marshalling units, it becomes more efficient to obtain the vectors ready for processing by a vector unit in the processor.

Hence, in some examples, the output interface circuitry may output to the data storage circuitry at least one vector of elements loaded by the respective traversal circuit units in a given active layer of the data structure traversal circuitry, to enable the processor to perform vector computation operations on the at least one vector of elements. For example, the data structure marshalling unit may be a near-core accelerator which is tightly coupled with the processor itself. There is no need for the data structure marshalling unit itself to perform arithmetic/logical operations on the loaded data elements itself, as this can more efficiently be handled by the processor. Rather, the data structure marshalling unit can be provided for accelerating the memory accesses for marshalling the elements from the data structure(s) into a format which can be processed by the processor.

However, depending on use case, it is also possible for the data structure marshalling unit to load data elements from memory and then write them in a different format/ordering into another region of the data storage circuitry, so it is not necessary for the processor to directly process the loaded data immediately in response to the data structure marshalling unit outputting the vector operands. For example, the output interface circuitry may output the at least one vector of elements to a given memory address region, ready for processing at some later time. Hence, it is not essential for the data structure marshalling unit to trigger any action from the processor itself at the time of outputting vectors of elements to memory.

Each traversal circuit units loads at least one stream of elements according to programmable iteration range. For example, to define the programmable iteration, start and end positions for the iteration range may be provided. Also, a traversal circuit unit may be provided with address information (e.g. there may be separate address information for each stream of elements in cases when the traversal circuit unit is loading more than one stream). Optionally, the programmable iteration range defining information may also specify a step parameter which indicates an increment amount between successive positions in the iteration range. Hence, starting from the start position and stepping through successive positions of the iteration range until the end position is reached, for each position in the iteration range, the address information and an iteration counter used to track progress through the range can be used to derive the address of a next element to be loaded for each of the at least one stream of elements. The traversal state machine for controlling such iteration may be implemented in hardware so does not need explicit software control to track the iteration progress.

The data storage circuitry may comprise data storage circuitry accessible to the processor. For example, the data storage circuitry accessed by the data structure marshalling unit can comprise part of the memory system accessible to the processor. For example, the data storage circuitry could include one or more caches and/or main random access memory of the processor. In some examples, the data storage circuitry accessed by the data structure marshalling unit could include non-coherent storage (e.g. scratchpad memory) and/or device/buffer interfaces (e.g. a direct buffer to a processor register, fixed-function circuitry, or a PCle port).

In some examples, the data structure marshalling unit can be provided with direct access to the memory system shared with the processor. The point of the memory system at which the data structure marshalling unit injects load/store requests can vary. For example, the memory system may comprise a hierarchy of memory storage including one or more caches (which could include one or more private caches private to the processor and/or one or more shared caches shared by the processor and at least one further processor), as well as main memory (random access memory) providing the backing store from which a subset of data is cached by the caches. The requests made by the data structure marshalling unit to load elements of data structures from, and output elements to, the memory system can bypass the load/store unit of the processor used to generate requests issued to the level 1 private cache of the processor, so that it is not necessary for data structure marshalling load/store requests issued by the data structure marshalling unit to occupy load/store slots in the processor's load/store unit.

In some examples, the output interface circuitry may output the at least one vector of elements to a private cache of the processor. By outputting to a private cache the processor, this can be efficient for preparing operands ready for processing by the processor itself, as subsequently loading those operands to the processor for processing can be faster than if the operands were injected into a level of the memory hierarchy further from the processor. For example, the private cache could be a level 2 cache of the processor (level 2 cache being the level accessed in response to a miss in the level 1 private cache, where level 1 is the first level of cache looked up for load/store requests issued by the load/store unit of the processor).

In some examples, each traversal circuit unit may issue, to a shared cache shared by the processor and at least one further processor, load requests for loading the at least one stream of elements. The relatively non-linear access patterns for loading the stream of elements from the data structures mean that the likelihood of a hit been detected in the private cache of the processor may be lower, and so to avoid consuming look up bandwidth and cache capacity in the private cache for elements of the data structures which are temporarily accessed by the data structure marshalling unit during the traversal but which are not required to be output in the output vectors, it can be useful to direct the load requests from the traversal circuit units to a shared cache further from the processor.

Hence, the combination of issuing load (read) requests to the shared cache but outputting the vector/scalar operands of loaded elements to the private cache can be particularly beneficial for performance.

For at least one programmable setting, the given traversal circuit unit in the downstream layer may start performing iterations of the programmable iteration range in response to at least one internal token generated by at least one traversal circuit unit in the upstream layer indicating that one or more elements loaded by the at least one traversal circuit unit in the upstream layer are available after being loaded from the data storage circuitry. Hence, this implements the dataflow architecture of the data structure traversal circuitry to help improve performance compared to a control flow architecture.

For at least one programmable setting for the output interface circuitry, the output interface circuitry may output the at least one vector of elements loaded by the respective traversal circuit units to a location in the data storage circuitry corresponding to an address determined based on the at least one stream of elements loaded by one of the traversal circuit units of the data structure traversal circuitry. This could be useful, for example, for workloads which have a preliminary data gathering phase which load scattered data from memory and write the loaded data into a densely packed structure which can then later be used in a second phase of processing by the processor. With this type of use case, it is not necessary to present operands for direct processing by the processor at the time of performing the preliminary data gathering phase. For example, this approach can be helpful for handling deep learning recommendation models.

Some examples may support at least one programmable setting for which the data structure traversal circuitry is responsive to detection of at least one traversal event occurring for the given active layer of the data structure traversal circuitry to trigger output of at least one callback token to the data storage circuitry, each callback token comprising a callback function identifier indicative of a function to be performed by the processor on elements output to the data storage circuitry by the output interface circuitry. This approach can be useful for use cases where the data loaded by the data marshalling unit is to be processed right away by the processor. In this case, it can be helpful for the data marshalling unit to output certain tokens representing the point of the data marshalling flow reached, which can be used to signal to the processor when there is relevant data to be processed and indicate which of a number of alternative processing functions is to be applied to that data. For example, the callback tokens (and any callback arguments, such as vector/scalar operand data output by the data structure marshalling circuitry based on the loaded elements) may be written to an output queue structure located at a particular address region of the memory address space used by the processor to access the memory system. This approach can be useful for use cases such as sparse tensor algebra.

For example, the traversal event which triggers output of a callback token could include any of the following: completion of an individual iteration of the programmable iteration range by one or more traversal circuit units of the given active layer; start of a first iteration of the programmable iteration range by one or more traversal circuit units of the given active layer; and/or completion of a final iteration of the programmable iteration range by one or more traversal circuit units of the given active layer. The data structure marshalling unit may have a programming interface which can allow the processor to select which of such traversal events should trigger output of callback tokens. Support for these various types of traversal event can be useful to implement sparse tensor algebra where it may be useful to implement callbacks to trigger the processor to perform certain arithmetic operations such as accumulator clearing (e.g. in response to the callback generated at the start of the first iteration), multiply-accumulate operations (e.g. in response to the callback generated after each individual iteration is complete) and writeback of calculated accumulator values to memory (e.g. in response to the callback generated on completion of the final iteration). By using the callback tokens, the processor can understand the structure of the stream of vector/scalar operands output for processing and understand how these relate to the iteration ranges being processed by traversal circuit units of the data structure marshalling unit. By offloading such arithmetic operations to the processor, rather than performing them on the data structure traversal circuitry itself, the relatively performance-efficient vector processing units typically present in modern processor cores can be exploited which can improve performance compared to performing these operations on arithmetic circuitry within the data structure marshalling unit.

The multi-lane structure of the data structure traversal circuitry can be exploited to improve performance by parallelising various data structure traversal operations. This can be done in different ways.

For example, some examples may support at least one programmable setting of the data structure traversal circuitry for which the programmable iteration range for each of a plurality of traversal circuit units in different lanes of the downstream layer is dependent on one or more elements of the at least one stream of elements loaded by a single traversal circuit unit in an upstream layer of the data structure traversal circuitry. Hence, this provides the ability to broadcast elements loaded by one upstream traversal circuit unit to multiple traversal circuit units in a downstream layer, so that those downstream circuit units can operate in parallel to load respective streams of elements based on a single index stream loaded by the upstream unit. Often, processing workloads accessing such multi-dimensional data structures such as tensors may require the same data from one portion of the structure to be combined with data from multiple other portions of the structure in different combinations. The broadcast functionality can therefore be useful for allowing the load cost of loading the required data elements to be reduced by amortizing the effort of loading a given portion of the structure in the upstream layer by reusing those elements for controlling loading of multiple streams of elements by two or more traversal circuit units in the downstream layer. Hence, the broadcast functionality can help to improve performance for workloads involving these types of data access patterns.

Some examples may support at least one programmable setting of the data structure traversal circuitry for which traversal circuit units in different lanes of the given active layer are configured to perform, in lockstep, iterations of respective programmable iteration ranges to load respective subsets of elements from the data storage circuitry, where for a given iteration, a given vector of the at least one vector of elements comprises one or more elements loaded by the plurality of traversal circuit units of the given active layer for the given iteration. For example, where the data structure is a tensor structure representing an n-dimensional array of elements (possibly stored in a sparse format where one or more index structures identify the positions of non-zero elements in the tensor and the values of those non-zero elements are stored in a dense format accessed based on the index values loaded from the index structures), the traversal circuit units in a given layer could be configured to load respective subsets of elements from the same tensor fiber (a tensor fiber being a one-dimensional slice of the tensor structure) or load elements from the corresponding index positions in two or more different tensor fibers. The lockstep control means that the iterations of the respective traversal circuit units operating in lockstep progress in sync, so that the timings of output of corresponding elements can be aligned to enable marshalling the elements loaded for a given position in the iteration range into vector operands. This helps to improve performance when the processor core processes the vector operands, compared to alternative implementations where the loaded data elements are processed singly in scalar form. It is not necessary that each of the parallel traversal circuit units operating in lockstep outputs an element for the vector in each iteration. In some iterations a padding value (e.g. zero) could be output for one or more of the vector elements as there may be no corresponding element to load from memory if that iteration corresponds to a zero element which is not explicitly stored for a sparse tensor.

In some examples, the data structure marshalling unit may comprise merging circuitry to compare elements of respective first streams loaded by two or more traversal circuit units in different lanes of a given layer of the data structure traversal circuitry, to determine one or more sets of merging predicates (each set of merging predicates corresponding to a respective index value specified by an element loaded for at least one of the respective first streams, and indicating which of the two or more respective first streams include an element having that given index value). The merging circuitry determines, based on the one or more sets of merging predicates, which elements of respective second streams loaded by the two or more traversal circuit units of the given layer are to be processed in a given processing cycle by a downstream layer of the data structure traversal circuitry or the output interface circuitry. Such merging circuitry can greatly improve processing performance for use cases where the data structure being processed is a sparse tensor structure. The merging is helpful for identifying, when sparse tensors are to be manipulated through arithmetic operations such as addition or multiplication, which index positions in the tensor structure will actually contribute to the end result, allowing those positions which will not contribute to be dropped without outputting corresponding data values to the data storage circuitry for subsequent processing by the processor. Performing such merging control in software on a general purpose processor can be particularly problematic for performance because the merging decisions may require a significant number of comparisons between index values specified in respective streams of elements loaded from respective portions of tensor structures, with data-dependent control flow decisions being made based on those comparisons. By providing merging circuitry implemented in hardware within the data structure marshalling units which can compare elements of respective streams to generate merging predicates and determine based on the merging predicates which elements loaded in one layer of the data structure traversal circuitry should be forwarded to a downstream layer, this eliminates the need for such merging control flow to be implemented in software and so eliminates the branch misprediction penalty associated with those operations, greatly improving performance.

The merging circuitry may implement different forms of merging, which can be programmably selected depending on the type of operation to be performed on the loaded elements.

In some examples, for at least one programmable setting for the merging circuitry (e.g. for implementing conjunctive merging), the merging circuitry may exclude, from processing by the downstream layer or the output interface circuitry, elements of the respective second streams associated with a set of merging predicates indicating that at least one of the respective first streams did not comprise any element specifying the index value corresponding to that set of merging predicates, even if there is at least one of the respective first streams that did comprise an element specifying that index value. This can be helpful for supporting multiplication operations performed on sparse tensor structures, for example.

In some examples, for at least one programmable setting for the merging circuitry (e.g. corresponding to disjunctive merging), the merging circuitry may enable processing, by the downstream layer or the output interface circuitry, of elements of one or more of the respective second streams indicated by a corresponding set of merging predicates as corresponding to a given index value specified by an element in at least one of the respective first streams. In this case, even if one of the second streams does not comprise an element corresponding to the given index value, the downstream layer can still be forwarded the elements loaded for that given index value in the second stream processed by at least one other of the traversal circuit units in the upstream layer. Disjunctive merging can be helpful for supporting addition operations performed on sparse tensor structures, for example.

The data structure marshalling unit may comprise arbitration circuitry to arbitrate between load requests issued by the respective traversal circuit units, to select load requests for issue to the data storage circuitry. As the traversal circuit units operate according to a data flow architecture, there is no preset timing at which traversal circuit units may be triggered to perform their load requests, and so the number of load requests issued in a given processing cycle may be extremely variable, and so sometimes the arbitration circuitry may have to prioritise between the requests when there are too many requests to be handled in a given cycle. When performing such arbitration, it can be useful for the arbitration circuitry to apply an arbitration policy in which, in the event of contention for load request bandwidth between load requests issued by traversal circuit units in different layers of the data structure traversal circuitry, load requests issued by traversal circuit units in an upstream layer of the data structure traversal circuitry have a greater probability of being selected than load requests issued by traversal circuit units in a downstream layer of the data structure traversal circuitry. This can be helpful because typically the upstream layer may implement an outer loop of a nested loop traversal operation and the downstream layer may implement an inner loop which depends on elements loaded in the outer loop, and so if the upstream layer is delayed in having its load requests serviced, this may cause knock-on delays in each downstream layer. Therefore, performance can be improved by providing a greater probability of selection for the load requests issued by traversal circuit units in an upstream layer than for load requests issued by traversal circuit units in a downstream layer.

The data structure marshalling unit may comprise an internal buffer to buffer values obtained in data structure traversal processing performed by the traversal circuit units. It can be useful to implement the internal buffer so that its buffer capacity is dynamically partitionable, to allocate variable amounts of buffer capacity to different traversal circuit units depending on a programmable setting selected for the data structure traversal circuitry. As different programmable settings for the data structure traversal circuitry may correspond to more or fewer traversal circuit units being in use, it can be useful to allow any buffer capacity which would otherwise be used by the inactive traversal circuit units to be reallocated to an active traversal circuit unit, so that the active traversal circuit unit is less likely to have to stall operations due to running out of buffer capacity.

In some examples, it can also be useful to allocate the buffer capacity so that traversal circuit units in a downstream layer are provided with greater buffer capacity in the internal buffer than traversal circuit units in an upstream layer. Again, recognizing that typically be upstream layer may implement the outer loop of a traversal function and the downstream layer may implement an inner loop, one may expect that the traversal circuit units in the downstream layer may need to carry out multiple iterations of the inner loop for each single iteration of the outer loop, and so the frequency of load requests to load elements from memory may be higher for the traversal circuit units in the downstream layer than for the traversal circuit units in the upstream layer. Performance can therefore be improved by allocating more buffer capacity to the downstream layer than the upstream layer.

Although the data structure traversal circuitry may be applied to a wide range of use cases for accessing different types of data structure, the data structure traversal circuitry may be configured to support loading of elements from a sparse tensor data structure. A sparse tensor data structure may comprise at least one index structure specifying index values used to identify which positions within an n-dimensional tensor structure are non-zero, and at least one value array structure specifying the data values for those non-zero positions within the tensor structure. The data structure marshalling unit can be particularly helpful for accelerating workloads operating on sparse tensors.

To support such sparse tensor operations, the data structure traversal circuitry may support loading of elements of tensor fibers according to one or more sparse tensor formats. For example, there may be support for multiple different sparse tensor formats by providing the data structure marshalling unit with a programming interface which enables selection, based on a programmable input provided by the processor, of one of a number of different iteration patterns for the programmable iteration range of a given traversal circuit units and/or different ways in which a downstream layer of traversal circuit units can be controlled based on elements loaded by an upstream layer of traversal circuit units, corresponding to different types of sparse tensor format.

The data structure marshalling unit may also support a set of element loading primitive functions which are sufficient to be tensor-algebra-complete, so as to support any generic tensor algebra function to be processed by the processor on the vector operands output by the output interface circuitry. Hence, rather than accelerating only certain specialized forms of tensor algebra, the data structure marshalling unit may offer performance speed ups over a wide range of possible sparse tensor workloads.

### Specific Examples

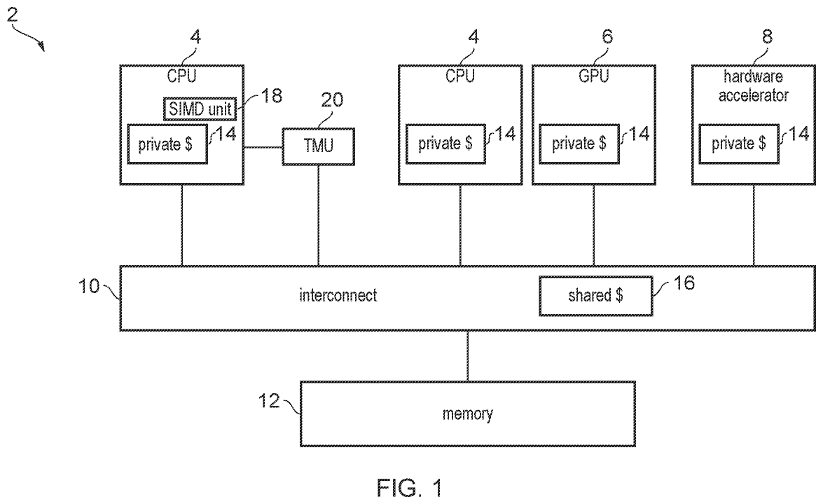

FIG. 1 illustrates an example of a data processing system 2 comprising a number of processors 4, 6. For example, the processors could include one or more central processing units (CPUs) 4, and/or one or more graphics processing units (GPUs) 6, and although not illustrated in FIG. 1 could also include other types of processors such as a neural processing unit (NPU), a specialist type of processor used to accelerate neural network processing. The processors 4, 6 share access to a shared memory system 12 accessible via an interconnect 10. The system 2 may also include one or more other requesting devices, such as a hardware accelerator 8 which is programmable by a processor 4 by writing to queue structures stored in the memory system 12, and which is responsive to commands written to such queue structures to perform various operations on data loaded from memory and write the results back to memory, from which the results can be read by the CPU 4. The interconnect 10 manages coherency between private caches 14 of the processors 4, 6 and hardware accelerator 8, and comprises a shared cache 16 shared between the processors 4, 6 and hardware accelerator 8 (and, if provided, any other requesting device that has its own private cache). At least some of the processors 4, 6 (e.g. one of the CPUs 4 in the example in FIG. 1) has a SIMD (single-instruction-multiple-data) unit 18, also known as a vector processing unit, for performing data processing operations on vector operands comprising two or more independent data elements.

Although not shown in FIG. 1 for conciseness, the memory system accessible to the processors 4, 6 may also include other forms of storage, such as non-coherent storage (e.g. scratchpad memory) and/or device/buffer interfaces (such as a direct buffer to a CPU register, fixed-function circuitry, or a PCle port).

Recent advancements in multilinear algebra have opened up new avenues for solving a wide range of problems using tensor algebra methods. A tensor is an n-dimensional array of elements, and is a generalization of vectors (one-dimensional array) and matrices (two-dimensional array) into any number of dimensions. A one-dimensional slice of the tensor is referred to below as a tensor fiber. For example, in a matrix (a tensor of order n=2), a tensor fiber could be an individual row or column of the matrix.

Tensor algebra methods are effective in various domains, including scientific computing, genomics, graph processing, and both traditional and emerging machine learning workloads. Typical operands of these applications can include both (i) large sparse tensors, which store multilinear relationships among the entities involved in the problem, and (ii) smaller dense tensors, which store entities' features. Given the high sparsity of these relationships (i.e., most values of the multidimensional space are zeros), generally above 99%, sparse tensors are typically encoded in compressed formats only storing non-zero values and their positions.

Although these formats help reduce sparse problems to tractable complexities, computation involving sparse tensors requires intensive traversal and merging operations to aggregate tensor operands. Both traversal and merging have extensive data-dependent control flow, leading to frequent branch mispredictions and consequent pipeline flushes that limit performance. Moreover, traversals typically load non-contiguous data, leading to irregular memory access patterns that generate long-latency memory accesses, further hindering performance. Overcoming these limitations by scaling-up components in current processors is not feasible, requiring different solutions.

The technique described here exploits the property that sparse tensor methods can be decomposed into three stages: (i) tensor traversal, (ii) merging, and (iii) computation. Tensor traversal and merging operations can generally be implemented as a deep nested-loop structure that can be expressed as a dataflow formulation. Hence, we propose to accelerate tensor traversal and merging to a dedicated near-core dataflow engine, called the Tensor Marshaling Unit (TMU), designed to marshal data into the core, which performs the computation. The TMU is an example of the data structure marshalling unit discussed above. While the examples below discuss the TMU accessing, as the data storage circuitry mentioned above, the memory system accessible to an associated processor 4, it will be appreciated that the data storage circuitry accessed by the TMU could also include other types of storage such as non-coherent storage and device/buffer interfaces as mentioned above.

The TMU can be programmed to perform traversal and merging operations of arbitrarily complex tensor algebra expressions. Moreover, the TMU enables parallel data loading, exposing additional memory-level parallelism. By performing parallel data loading, a vector-friendly layout can be obtained, i.e., elements loaded in parallel can be packed contiguously into vector operands; thereby marshalling data into the core that can be computed efficiently using single instruction multiple-data (SIMD) instructions. The TMU also allows decoupling data loading/merging from computation, permitting both the TMU and the compute core to operate in parallel in a pipelined fashion. In contrast to standalone accelerators, the TMU leverages existing core components such as functional units and caches to compute and store partial results; providing additional flexibility to customize computation, accumulation, partial result writing.

Hence, as shown in FIG. 1, one or more of the processors 4, 6 (in this example, one CPU 4 that also has a SIMD unit 18) is provided with a TMU 20. While FIG. 1 shows the TMU being provided private to one CPU 4, in other examples the TMU 20 could be shared between two or more processors 4, 6. The Tensor Marshaling Unit (TMU) is a near-core programmable dataflow engine, suitable for multicore architectures, that accelerates tensor traversals and merging, the most critical operations of sparse tensor workloads running on today's computing infrastructures. The TMU leverages a multi-lane design that enables parallel tensor loading and merging, which naturally produces vector operands that are marshaled into the core 4 for efficient SIMD computation. The TMU supports a set of primitives that is tensor-format-complete and tensor-algebra-complete, enabling the CPU 4 to efficiently perform generic tensor algebra workloads without restriction to specific type of tensor algebra. This differs from typical approaches to accelerating tensor arithmetic using a far-core hardware accelerator 8 accessed via the interconnect 10, which are often limited to specialized forms of tensor algebra and are not complete in regard to the set of primitives supported. Also, unlike the near-core accelerator approach for the TMU 20, for which the TMU 20 is tightly integrated into the cache hierarchy 14, 16 of a processor 4 enabling injection of store requests into a private cache 14 of the processor 4, such far-core hardware accelerators 8 will be limited to interacting with a processor 4 via shared data structures stored in the shared cache 16 and main memory 12 and so would be less efficient for workloads which require relatively short patterns of loading interspersed with arithmetic operations on the processor 4 using the loaded values. For this reason, such far-core hardware accelerators 8 often have their own arithmetic logic for carrying out basic arithmetic functions, but such arithmetic logic will typically be limited in the types of tensor algebra supported, and in any case will be much less performance-efficient than the high-performance SIMD processing units 18 supported by typical modern CPUs 4. Hence, by providing the TMU as a near-core accelerator for performing the load requests for marshalling accesses to complex structures in the memory system, to obtain vector operands that can be injected into the private cache 14 of a processor 4 for processing by the SIMD processing unit 18 on the associated processor 4, performance can be accelerated to much greater extent than is typically possible using a far-core hardware accelerator 8.

Before discussing the TMU 4 in more detail, we discuss background to tensor algebra. We consider an order-n tensor an n-dimensional data collection. Aᵢⱼₖ is the scalar element at position i, j, k of an order-3 tensor A. Einsum expressions leverage this index notation to describe tensor computation. Einsum expressions describe tensor computation through the Einstein summation convention that describes how input/output dimensions relate: (i) input dimensions with repeated indexes are combined element-wise, (ii) input dimensions whose index is omitted in the output tensor are contracted, and (iii) other dimensions are just copied to the output. For instance, matrix addition is written as Zᵢⱼ=Aᵢⱼ+Bᵢⱼ, meaning all elements of A and B are summed elementwise. Matrix-vector multiplication, instead, is written as Zᵢ=AᵢⱼBⱼ. As dimension j does not appear in the output tensor, it needs to be contracted (i.e., multiplied elementwise and summed up). Similarly, matrix-matrix multiplication would be Zᵢⱼ=AᵢₖBₖⱼ, with a contraction on k. These expressions are typically implemented in software as a deep loop hierarchy, each loop traversing and combining tensor fibers, which are one-dimensional views of a tensor (e.g., matrix rows/columns). The loop order, instead, is defined by an index schedule. For instance, an inner-product implementation of matrix multiplication has a schedule set to i jk, outer-product to ki j, and dataflow to ik j. However, the iteration boundaries of these loops depends on the format input tensors are stored in.

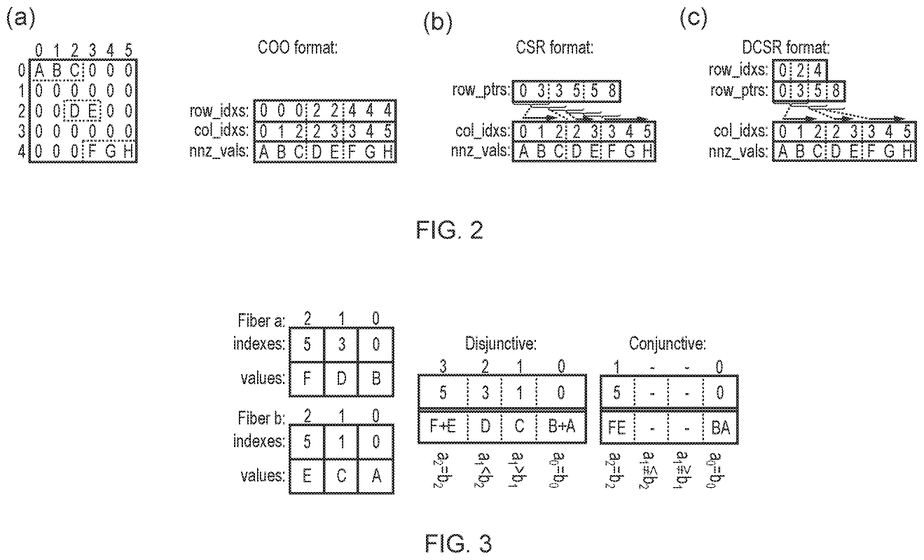

Dense tensors store their fibers contiguously according to a given data layout (e.g., row or column major). In contrast, sparse tensors use compressed formats to only store non-zero values (nnzs) and their position. FIG. 2 summarizes a number of common compression formats for matrices. The Coordinate format (COO), in part (a) of FIG. 2, explicitly stores the non-zero positions as n-dimensional coordinates, which are typically sorted by some multidimensional ordering (e.g., row/column major). For matrices with #nnzs>#rows+1 (where #nnzs is the number of non-zero elements and #rows is the number of rows in the structure), the Compressed Sparse Row (CSR) format (part (b) of FIG. 2) improves COO storage by replacing the row_idxs with an array, the row_ptrs, that stores the starting position of each row into the value array (so that the number of elements in a given row i is encoded as the difference between row_ptrs[i] and row_ptrs[i+1]). For matrices with #rows greater than twice the number of non-empty rows, the Doubly-Compressed Sparse Row (DCSR) format (part (c) of FIG. 2) improves CSR storage by compressing empty rows of the row_ptrs array by specifying the indices of the non-zero rows in a structure row_idxs separate from the structure row_ptrs pointing to the column index structure. Higher-dimensional tensors, instead, are generally stored as COO or in Compressed Sparse Fiber (CSF) format, which is a generalization of DCSR to multiple dimensions, thereby compressing all tensor fibers.

Chou et al. (“Format abstraction for sparse tensor algebra compilers,” Proc. ACM Program. Lang., vol. 2, no. OOPSLA, October 2018) formalize a hierarchical abstraction to express these and other tensor formats using six level formats. For instance, with this abstraction, CSR can be defined by combining a dense and a compressed level, whereas DCSR requires two compressed levels. Instead, COO can be defined as a set of singleton levels, one for each tensor dimension, and CSF as a hierarchy of compressed levels. This way, one can build arbitrarily-complex formats to optimize performance and storage efficiency of a given algorithm.

Each compressed level format can be traversed (i.e. iterated and loaded) with a specific level functions such as:
1. Dense traversal:
for(idx=0; idx<fbrSize; idx++)
   val=vals[idx];
2. Compressed traversal:
for(p=ptr[i]; p<ptr[i+1]; p++)
   idx=idxs[p];
   val=vals[p];
3. Coordinate singleton traversal:
for(p=0; p<numNnzs; p++)
   idx0=idxs0[p];
   idxl=idxsl[p];
   val=vals[p];
      Hence, tensor traversal can be implemented by nesting these functions into a deep loop hierarchy. To perform computation, multiple tensors can be co-iterated and combined together, usually at the fiber level.

While multiple dense fibers can be co-iterated with a simple for-loop structure, co-iterating compressed (or dense and compressed) fibers requires a merging operation. As shown in FIG. 3, disjunctive merging co-iterates multiple fibers and, for each iteration, assuming sorted coordinates, outputs and steps the fibers with the minimum coordinate, to output sets of elements for which elements with same indexes can be added together (the add is performed by the processor 4 after the elements are loaded by the TMU and output to the memory system).

Conjunctive merging works similarly but only outputs a value if all the output fibers have the same coordinate, so that the remaining elements are those where each of the merged fibers contain the corresponding coordinate, allowing those elements having corresponding coordinates to be multiplied by the processor 4 after being output by the TMU 20. This is useful because adding two CSR matrices can use disjunctive merging to join fibers (as 0+x=x), whereas element-wise multiplication can use conjunctive merging to intersect fibers (as 0×x=0). These operations require extensive comparisons which are typically implemented in software with while loops and if-then-else constructs. In practice, however, the intersection of a compressed and a dense fiber (see the SpMV workload example discussed below) is usually implemented as a scan-and-lookup operation with constant complexity (i.e. loading elements corresponding to each coordinate that appears in either fiber to avoid the coordinate comparison overhead, which for conjunctive merging can be wasteful as many of the loaded elements may be zero in at least one of the fibers).

After merging, fiber elements are computed and written back to memory (e.g., lines 8 and 10 in the example below). If the output is dense, data can be stored right away. However, if the output is compressed, the algorithm is generally implemented in two steps: a symbolic phase, which computes (or estimates) the size of the output data structure, and a numeric phase, which performs actual floating-point computation and writing. In this context, another fundamental operation is tensor reduction, where different fibers are accumulated into a single one. Specifically, given a stream of coordinates-value pairs with possibly repeated coordinates, a reduction operation outputs a stream of pairs with unique coordinates where input pairs with equal coordinates have values accumulated.

Hence, an example of a typical tensor processing workload is shown below, this example based on SpMV decomposition in fiber traversals and computation. The outer loop (lines 3-4) traverses the dense CSR fiber of row pointers. The inner-loop traverses the compressed CSR fiber and dense vector with a scan-and-lookup operation (lines 5-7 in blue). Compute happens at the inner-loop body (line 8) and tail (line 10) in green.

1 void spmv (v_ty* x, const csr_ty* a, const v_ty* b) {
2 v_ty sum = 0;
3 for (i_ty i = 0; i < a->num_rows; i++) {
4 p_ty p_beg = a->ptrs[i], p_end = a->ptrs[i+1];
5 for (p_ty p = p_beg; p < p_end; p++) {
6 v_ty vec_val = b[a->idxs[p]];
7 v_ty nnz_val = a->vals[p];
8 sum += vec_val * nnz_val; //inner-loop body (ri)
9 }
10 x[i] = sum; sum = 0; //inner-loop tail (re)
11 }
12 }

Hence, tensor expressions are composed of fiber traversals, merging, and computation. To study the performance impact of each of these stages, we select three tensor kernels as representative proxies of each stage:
Sparse Matrix-Vector Multiplication (SpMV), which multiplies a CSR matrix and a dense vector and outputs a dense vector (Zᵢ=AᵢⱼBⱼ). Since co-iteration of Aⱼ and Bⱼ is generally implemented as a memory-intensive scan-and-lookup operation, SpMV has a tight loop structure (e.g. see the code example above), whose control flow introduces non-negligible overhead for highly-sparse matrices. Hence, we consider SpMV a representative proxy for the traversal stage.
Gustavson's Sparse Matrix-Sparse Matrix Multiplication (SpMSpM), which multiplies and outputs CSR matrices (Zᵢⱼ=AᵢₖBₖⱼ with (ik j) schedule). SpMSpM performs the same scan-and-lookup operation as SpMV but, instead of scalars, it looks up and loads whole rows of B, which are then reduced (accumulated) into a single row. For this reason, SpMSpM is a good proxy to study: (i) scan-and-lookup scaling to higher spatial locality and (ii) computation performance.
Sparse Matrix Addition (SpAdd), which adds and outputs CSR matrices (Zᵢⱼ=Aᵢⱼ+Bᵢⱼ) by repeatedly coiterating and joining (disjunctive merge) matrix fibers with the same row-index i. Therefore, SpAdd is representative of merge-intensive kernels.

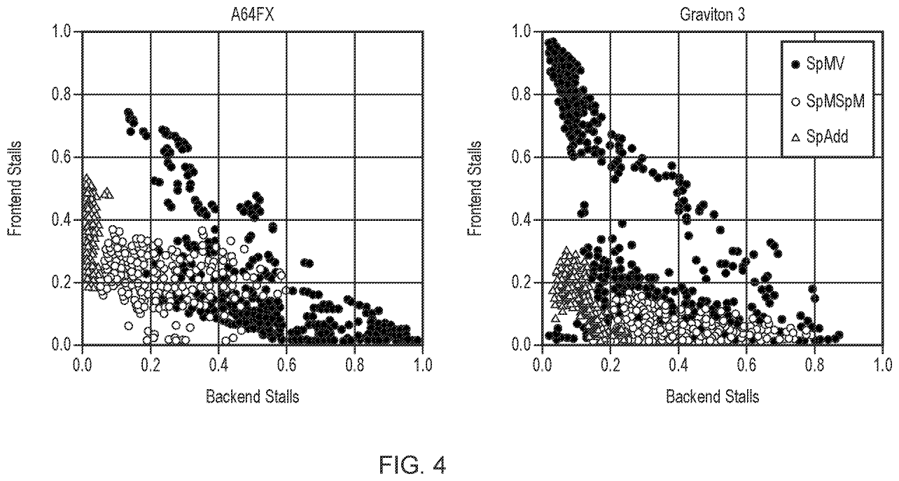

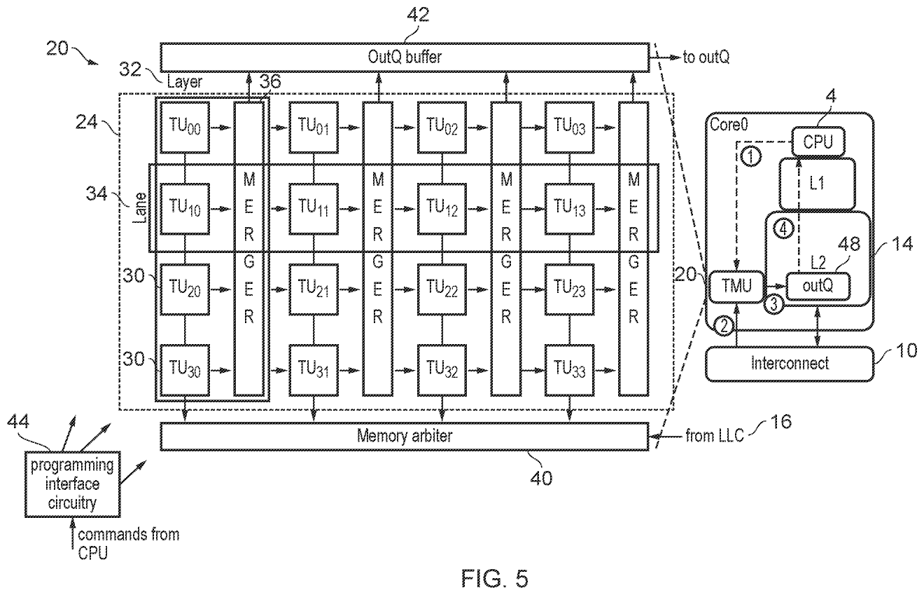

We profile these kernels both on an HPC processor, the Fujitsu A64FX, and a data-center processor, the AWS Graviton 3. While the A64FX has more memory bandwidth per core (1 TB/s for 48 cores vs. 300 GB/s for 64 cores), Graviton 3 has cores with more out-of-order resources and larger caches. FIG. 4 reports the portion of frontend (fetch) and backend (memory) cycle stalls (with respect to total cycles) when running the largest 100 matrices from the SuiteSparse Matrix Collection on the aforementioned kernels. That is, the frontend stalls are those caused by branch mispredictions, and represent loss of performance due to mispredicting the data-dependent control flow. The backend stalls represent cases when control flow was correctly predicted but an instruction's execution was delayed while waiting for required data from memory. Overall, we observe that sparse algebraic workloads have low CPU utilization, as a large portion of cycles is spent either in frontend or backend stalls. In particular, we find that:
1. The scan-and-lookup operation in SpMV performs better (fewer backend stalls) in architectures with larger caches, such as the Graviton 3, despite the lower per-core bandwidth. In fact, caches help filter long-latency memory accesses that saturate the limited ROB and MSHR resources of today's processors.
2. Despite better backend utilization, SpMV on Graviton 3 still suffers from high frontend stalls coming from compressed fiber traversal. Data-dependent branching code is hard to predict and generates costly pipeline flushes.
3. SpMSpM presents better backend utilization on the A64FX, which is also better with respect to SpMV. In contrast, on Graviton 3, SpMSpM has comparable backend utilization to SpMV. This suggests that (i) scan-and-lookup operations with higher spatial locality perform better in high bandwidth architectures, and (ii) reduction operations do not drastically impact backend utilization since partial results generally fit in cache. Computing these results, however, has better frontend utilization on more aggressive cores, like the ones in Graviton 3.
4. SpAdd has low frontend utilization due to data-dependent branching code, especially for cores with limited out of order capabilities like the ones in the A64FX.
   Hence, these results show that (i) current general-purpose processors generally have enough compute resources for the typical operational intensity of sparse algebraic workloads and (ii) existing cache hierarchies are quite efficient at capturing input locality (e.g., graph communities) and storing partial results. However, (i) data-dependent control flow from fiber traversal and merging and (ii) irregular memory accesses from scan-and-lookup operations prevent efficient system utilization, achieving just a fraction of the available peak performance.

Scaling-up components in current processors is not enough to overcome these limitations. Moreover, because of Moore's law coming short, we cannot expect significant improvements in the next years, requiring a more disruptive solution. To this end, we introduce the TMU, which enables offloading and accelerating costly traversal and merging operations.

FIG. 5 illustrates an example of the TMU 20, which comprises data structure traversal circuitry 24 comprising an array of traversal circuit units (or traversal units, TUs, for short) 30, logically arranged in a two-dimensional array comprising layers 32 and lanes 34. The data structure traversal circuitry 24 operates according to a data flow architecture with no preconceived order between the operations performed by each TU 30. Instead, TUs in a downstream layer 32 of the data structure traversal circuitry 24 are triggered to carry out their traversal operations based on the availability of the input data received from an upstream layer of the data structure traversal circuitry 24. Internal tokens passed from one layer to another can be used to signal when the input data required for a downstream layer is available. In FIG. 5, the data flow direction is from left to right so that for any given pair of layers 32, the upstream layer is the one of that pair of layers that is further to the left of the diagram and the downstream layers is the one of that pair of layers that is further to the right of the diagram. Of course, while FIG. 5 shows a logical arrangement of the TUs, in practice the TUs may be implemented on an integrated circuit in any physical arrangement, which does not necessarily need to follow a regular grid shape as shown in FIG. 5 (although such a regular grid may be more efficient for circuit timings and circuit area utilisation).

Within each layer 32, two or more TUs 30 are provided to operate in parallel within their respective lanes 34. Each TU 30 is assigned a given iteration range to iterate through for loading at least one stream of elements from one or more data structures stored in the memory system 16, 12. For example, the iteration range may be defined using parameters indicating start/end positions for an iteration counter which is to be incremented by a given increment amount between one iteration and the next iteration (that increment amount could be fixed or could be variable based on a step size parameter defined for that TU 30). A given TU 30 may also be assigned one or more pieces of address information for each stream to be loaded according to the iteration range (e.g. for each stream, a base address may be provided relative to which addresses of the respective elements to be loaded for each iteration are to be calculated).

Hence, once a given TU receives its trigger to start its assigned set of iterations (for TUs in the first layer, that trigger could be a start command from the processor 4 or availability of any configuration data such as the iteration range defining data, while for TUs in downstream layers the trigger can be availability of input data generated by an upstream layer), the TU 30 starts stepping through its iterations and for each iteration calculates addresses of the next element to be loaded in each of the one or more streams assigned to that TU, and issues load requests for loading those elements of data from memory. For each stream being processed, the TU populates a corresponding queue structure (internal to the TU 30) with the loaded elements, maintained in an ordered structure so that the corresponding elements from each stream that correspond to the same iteration can be accessed as a group as they reach the heads of the respective queues. Tokens are passed onto the next layer once there is relevant data able to be processed downstream (e.g. once each queue includes loaded data at its queue head).

The TMU 20 comprises memory arbitration circuitry 40 (shared between the respective layers 32 of TUs 30), to arbitrate between load requests issued by the respective TUs 30. If there is insufficient memory request bandwidth to issue all of the load requests issued by the respective TUs 30 to the memory system in a given cycle, the arbitration circuitry 40 applies an arbitration policy which gives higher priority to requests issued by TUs in an upstream layer 32 in comparison to requests issued by TUs 30 in a downstream layer 32. This tends to improve performance because upstream TUs are more likely to be executing an outer loop for which delays in loading data from memory would have a knock on effect on performance for downstream layers handling an inner loop which relies on the data loaded by the upstream layer. Any known arbitration policy which is able to apply prioritisation in this way can be used For example, the prioritisation could be absolute (always prioritising requests from upstream layers over requests from downstream layers), or could be relative (e.g. while on most cycles requests from upstream layers may be prioritised over downstream layers, a quality of service scheme may be applied so that on some occasions a request from a downstream layer could be allowed to proceed even if there is an upstream request pending, to ensure that downstream layers are not completely starved of access to memory). Any load requests selected by the memory arbiter 40 are supplied to a given point of the memory hierarchy of the shared memory system accessible to the processor 4 which makes use of the TMU 20. For example, the TMU 20 may issue the load requests to the interconnect 10 as shown in FIG. 1, for accessing data within the shared cache 16. When the data requested by the load request is returned from the memory system, the loaded data is returned to the internal queue structures of the relevant TU 30 that requested the data.

Merging circuitry 36 is provided between the respective layers 32 of TUs 30, to control the way in which elements loaded by TUs 30 in an upstream layer 32 are provided to TUs 30 in a downstream layer 32. It is possible for a given TU 30 in a downstream layer to be configured to define its iteration range using parameters determined based on elements loaded in one of the streams loaded by a TU 30 in a preceding upstream layer. For example, an upstream TU 30 loading elements from an index structure can pass the loaded index values to a downstream TU 30 via the merging circuitry 36, so that those index values may then form the start/end positions of an iteration range to be used to control loading from a further structure (e.g. a tensor fiber) in a downstream layer. In this way, nested loop functions for traversing sparse tensor structures and other data structures involving indirection of memory access can be mapped onto the respective layers 32 (with an upstream layer executing outer loop processing and downstream layer executing inner loop processing for the nested loop). Hence, the data structure traversal circuitry 24 can replicate a traversal function such as the SpMV example shown above.

The merging circuitry 36 can support a number of functions which are useful to exploit the parallelism provided by the multiple lanes 34 of TUs 30. In one example, for a “Broadcast” programmable setting, the merging circuitry 36 enables elements loaded by one TU 30 in a preceding upstream layer 32 to be broadcast to multiple TUs 30 in a downstream layer, to allow those downstream TUs to operate in parallel loading respective portions of data structures under control of the same index values loaded by the upstream TU 30. Alternatively, a “single lane” setting may simply forward indices loaded by a given TU to a single TU in the same lane of the next layer, with multiple such “single lanes” being configured to operate in parallel in the respective lanes 34, so that each lane acts independently to load elements for a different tensor fiber traversal operation and there is no cross-lane flow of data between lanes. In a given layer, the TUs 30 could either operate independently (with one TU being able to step through its iterations at a different rate to another, depending on availability of input data), or could operate in “lockstep”, with each TU 30 acting as a lockstep group within the same layer stepping through its iterations at a common rate, so that the elements corresponding to a given iteration of that lockstep progress are synchronised in the timing at which they appear in the TUs' internal queues and so can naturally be marshalled into vector operands output by the TMU 30 where each vector operand comprises one element from each TU 30 in the lockstep group.

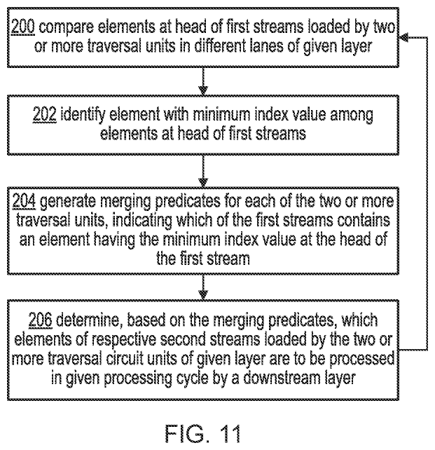

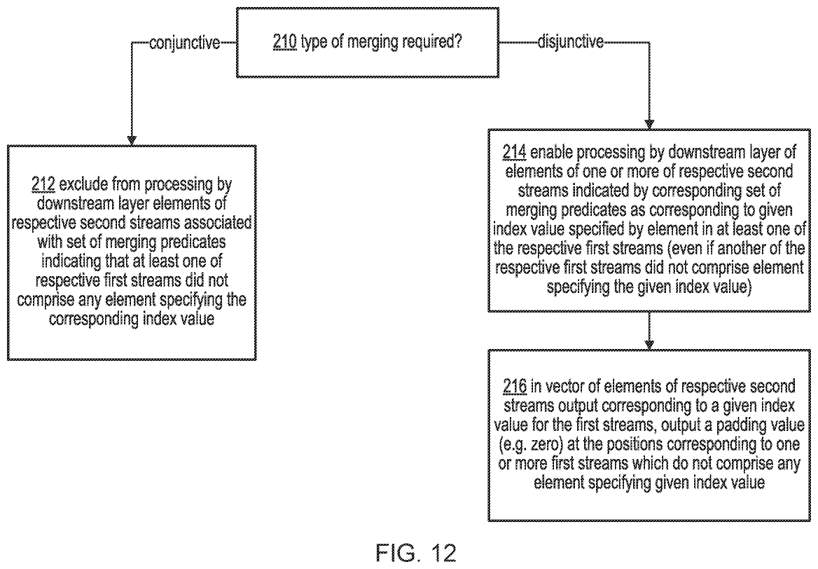

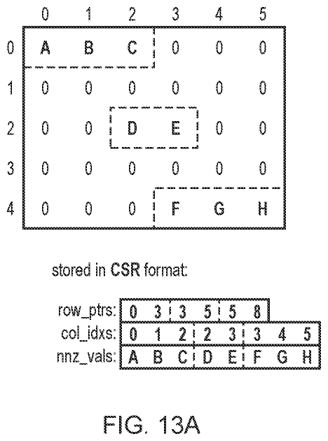

The merging circuitry 36 can also support merging operations based on merging predicate values computed based on comparison of elements loaded by respective TUs 30 in a given layer 32. This is discussed in more detail below with respect to FIGS. 11 and 12.

The merging circuitry 36 also handles the output of internal tokens from one layer 32 to the next to signal the availability of input data required for processing the traversals in the next (downstream) layer.

For a given TU 30, one or more traversal events may be registered with the TU 30, specifying instances when the TU 30 is to trigger output of loaded elements along with a callback token specifying a processing function to be applied to those elements. For example, the traversal event could be the TU 30 starting to perform the first iteration of its iteration range, or could be the completion of an individual iteration of its iteration range (regardless of whether iteration is the first iteration, an intermediate iteration or a final iteration of the iteration range), or could be the completion of the final iteration of the iteration range. When an individual TU 30 (or a group of TUs in a given layer 32 that have been configured to act as a group operating in lockstep) encounters such a traversal event having been configured to output a callback token in response to that traversal event, the corresponding merger 36 that receives the elements loaded by that TU 30 or group of TUs outputs to an output queue buffer 42 a callback token indicating the type of traversal event that occurred and operand data specifying the one or more elements loaded by that TU 30 or group of TUs 30. If a group of TUs 30 has been configured to operate in lockstep then the operand data may be specified as a vector of elements (one element per TU in the group).

Data from the output queue buffer 42 is marshalled into store requests which can be issued to the memory system for writing to a specified output queue structure 48 (e.g. an output queue address pointer may be provided by processor 4 identifying the address in the processor's address space that is used for the output queue data structure 48). For example, the output queue structure 48 may be managed as a first-in-first-out (FIFO) queue and the output queue buffer circuitry 42 of the TMU 20 may maintain an insertion pointer indicating the next entry of the output queue 48 to be updated (similarly when reading data from the queue to identify callback functions to be processed and the input operands to be used for such arguments, the processor may use a readout pointer which identifies the oldest unread entry of the queue, and may update the pointer to point to the next entry after reading out the previous entry).

Hence, by specifying in the output queue 48 callback tokens representing the type of traversal event encountered by the TU, the processor 4 can be triggered to execute corresponding functions (which can be branched to based on the value of the callback tokens) to carry out arithmetic operations on the elements loaded by the TMU 20. By not attempting to perform such arithmetic operations within the TMU 20 itself, the more efficient SIMD units 18 in the processor 4 can be exploited to improve performance.

While the store requests output from the output queue buffer 42 could be injected into various levels of the processor's memory system hierarchy, in the example of FIG. 5 the store requests are supplied to the level 2 private cache 14 of the processor 4, which has been found to give improved performance because injecting store requests to the level 1 cache risks evicting data that is still likely to be accessed by the processor 4 in the near future but injecting these store requests at a level 3 cache or last level cache (shared cache 16) risks the processor 4 experiencing too long delays in loading the callback tokens and operands for the callback functions from memory when processing data from the output queue 48. Hence, the level 2 cache 14 represents a more efficient entry point into the memory hierarchy for the TMU store requests which can give improved performance, but other examples may choose a different entry point.

As shown in FIG. 5, the TMU 20 also has programming interface circuitry 44, which accepts programming commands from the processor 4, and configures components of the TMU 20 (such as the TUs 30, merging circuitry 36, memory arbiter 40 and/or output queue buffer 42) based on those commands. For example, such programming commands can be used to define which TUs 30 are active as well as whether certain TUs 30 are to operate individually or in a lockstep group within the same layer 32. Also, the commands can define start/end positions and/or an iteration step size for the iteration range of at least the TUs in the initial layer 32 (layer furthest upstream) and optionally for other layers. Also, the programming commands can be used to specify how many streams are to be loaded by a given TU 30 in a given lane based on the index values loaded from an index stream, and to specify the particular way in which memory addresses of elements of the respective streams are to be derived from any base address information and an iteration counter tracking progress through the iteration range. Also, the programming commands may define how the merging circuitry 36 is to pass information from one layer to another (e.g. whether TUs of a downstream layer should operate on a lane-by-lane basis based on information from the corresponding TU in the same lane of the upstream layer, or whether a broadcast of information should occur from a single TU in an upstream layer to multiple TUs in a downstream layer). The programming commands may also specify whether any merging operations are to be performed by the merging circuitry 36, and if so what type of merging (conjunctive or disjunctive merging) is to be performed. The programming commands may also define which types of traversal (callback) event are to trigger output of callback tokens and scalar/vector operands of loaded data elements to the output queue 48 via the output queue buffer 42. The commands could also specify what arbitration policy should be used by the memory arbiter 40 and/or define the base address of the output queue structure 48 to which the output queue buffer 42 should output the callback tokens and operands specifying loaded elements.

As an example, the TUs 30 may be configured based on TU traversal primitive types as shown in Table 1 discussed further below (which control the iteration pattern applied for the iteration range), and based on data stream primitive types as shown in Table 2 discussed further below (which control the operation performed by the TU 30 for each iteration when following the configured iteration range). The merging circuitry 36 can be configured based on the inter-layer primitives shown in Table 3 described below.

The particular way in which the programming interface circuitry 44 accepts commands from the processor 4 can vary. In some examples, a set of TMU instructions may be supported within the instruction set architecture (ISA) used by the processor 4, so that when certain architectural instructions are executed by the processor 4, the CPU 4 sends corresponding commands to the TMU 20 which causes the programming interface circuitry 44 to set corresponding items of control data read by the TMU components 30, 32, 34, 40, 42 to influence their operation. Alternatively, the software executing on the processor 4 may use conventional store instructions to write command data to a control structure stored at a given region of the memory system, from which the programming interface circuitry 44 may read that command data and interpret the command data to determine how to set the internal configuration data which configures the operation of the various TMU components 30, 32, 34, 40, 42.

We now consider in more detail at how the TMU 20 can be applied to the SpMV example discussed above to implement the traversal operations for traversal a sparse tensor structure. We leverage the abstraction described above to express tensor operations as dataflow programs composed of traversal, merging, and computation phases. With this dataflow abstraction, we can offload tensor traversal and merging to the TMU, while keeping computation into the core. The code example above illustrates this decomposition for SpMV. As shown in the right hand portion of FIG. 5 giving an overview of the interaction between the CPU 4 and TMU 20, the TMU can (1) be programmed to (2) traverse and merge tensor operands and (3) marshal the aggregated data to the core 4 via a memory-mapped output queue (outQ) 48 that the core can (4) process. TMU traversal, merging, and marshaling is programmed with dataflow primitives whereas the compute code is wrapped in callback functions that the TMU triggers by outputting callback tokens on traversal/merging events.

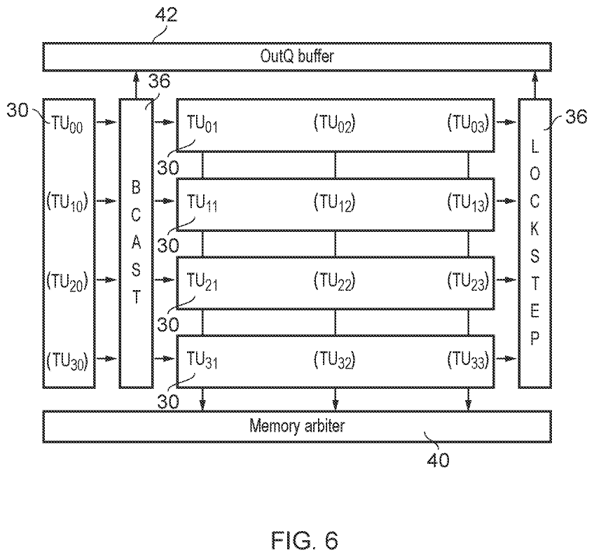

Traversal units, lanes and layers: As shown in FIG. 5, the TMU comprises a matrix of Traversal Units (TUs) 30 where each TU implements logic and storage to traverse a tensor fiber, for each of the for loops in the code example above (lines 3-4 and 5-7). Each of these for loops can be mapped to TUs of a TMU layer 32. As shown in FIG. 6, the for loop in lines 3-4 of the SpMV example would map to a given TU, TU₀₀, in the left-most layer, producing indexes that flow into the second layer, where the for loop in lines 5-7 would be mapped. Therefore, the TMU has a dataflow design that flows rightward. In addition, loop iterations can be parallelized using multiple rows, named lanes, which can also be used to load and merge multiple tensors.

Multi-lane parallelism: The values loaded by multiple lanes, either for parallel traversal or merging, are marshalled into vector operands. For example, each lane of the second layer that is traversing the for loop in lines 5-7 of the example above loads one vec_val and one nnz_val, which are then marshaled into vector operands. Hence, in FIG. 6, the TUs (TU₀₁, TU₁₁, TU₂₁, TU₃₁) are a TU group operating in lockstep fashion to load respective elements from multiple tensors (nnz_val, vec_val) according to the single stream of index values broadcast to those TUs from TU₀₀ in the first lane.

Callbacks and outQ processing: The software executing on the processor 4 may have defined some callback functions, such as the following:

1 ri_callback(vfloat nnz_vals, vfloat vec_vals) {
2 vfloat mul_vals = vec_mul(nnz_vals, vec_vals);
3 sum += vec_reduce(mul_vals);
4 }
5 re_callback( ) {
6 x[i++] = sum; sum = 0;
7 }

These functions are executed by the processor 4 in response to detecting the corresponding callback tokens appearing within the output queue 48 within its memory address space. These callbacks wrap the compute code of the body (n) and tail (re) regions of the inner loop shown in the SpMV example shown above. The ri callback accumulates partial-results (into the sum variable) and is triggered by the TMU at every row iteration (inner-loop body), i.e. at completion of each individual iteration of the iteration range set for the group of TUs in the second layer. The re callback stores results at the end of every row traversal (inner-loop tail), i.e. at the end of the programmed iteration range for the group of TUs in the second layer (the second layer of TUs may iteratively execute multiple instances of programmed iteration ranges based on each iteration of the outer loop handled by TU₀₀ of the first layer, so there would be one re callback for each iteration of the outer loop). To decouple TMU and core execution, the TMU sends to the core, through the outQ, a control/data stream defining the ordered sequence of callback tokens and operands that the core should process.

Fiber traversal: As described above for the dense, compressed and coordinate singleton traversal methods, all sparse and dense fiber traversals have the following for loop structure: for (i=beg; i<end; i+=stride).

Hence, each TU provides the logic and storage to iterate such a loop, (with beg and end for a TU in a downstream layer defined by index values loaded in the fiber traversal for a TU in an upstream layer), and load fiber values into streams.

Fiber iteration: Table 1 shows an example of the primitives we can use to program TUs to implement the fiber traversals:

TABLE 1

| Type | Description | Signature | Traversal |
|---|---|---|---|
| Dense | dense (or | DnsFbrT(int beg, int | for(i=beg; i<end; i+=stride) |
| | singleton) fiber | end, int stride=1) | |
| | scan | | |
| Range | compressed | RngFbrT(stream beg, | for(i=beg.head( )+offset; |
| | filter lookup | stream end, int | i<end.head( ); i+=stride) |
| | and scan | offset=0, int stride=1) | |
| Index | dense fiber | IdxFbrT(stream beg, int | for(i=beg.head( )+offset; |
| | lookup and | size, int offset=0, int | i<beg.head( )+size; i+=stride) |
| | scan | stride=1) | |

For instance, we can use a Dense primitive to implement the outer loop of the SpMV example, to iterate through matrix rows and load the row pointers. These pointers, loaded into streams, are then used to implement the inner-loop traversal, with a Range primitive, to load non-zero values and column indexes (compressed levels), which, in turn, are used to load dense vector values through scan-and-lookup. SpMM (Zᵢⱼ=AᵢₖBₖⱼ), instead, works similarly but requires an additional inner loop, implemented with an Index primitive, to scan entire rows of the right-hand side matrix (Bₖ).

Data loading: Once the iteration space of a TU is defined, data loading is implemented through the data streams primitives listed in Table 2:

TABLE 2

| Type | Description | Function |
|---|---|---|
| mem | loads p's elements from memory at index x | p[x] |
| ite | generates TU iteration indexes ∈[beg,end) | x:beg→end |
| lin | implements a linear transformation on x | ax + b |
| map | reads x-th element of a small map a={v1, ..., v16} | a[x] |
| ldr | computes the address of the x-th element in p | &p[x] |
| fwd | forwards a TU stream received from an upstream | — |
| | layer to the next downstream layer without change | |
| msk | outputs a layer predicate for merging and lockstep | — |
| | operations | |

The mem stream loads data from a base address and a stream of indexes. To generate the index stream, TUs push their current iteration index (i.e., loop induction variable) into an ite stream, which can also be transformed with lin or map streams. Indirect accesses can be implemented by chaining mem streams. Hence, we can represent a fiber traversal with a parent-children dependency tree where the ite stream is the root. For instance, the SpMV scan-and-lookup operation shown above is implemented by instantiating two mem streams: a parent stream that loads the column indexes which are then used by its child stream to index into the dense vector.

Fiber merging and parallelization: We can use multiple TMU lanes to parallelize loop traversal or merge different tensors. Parallelization and merging can happen at any tensor level by setting TMU layers to one of the configurations shown in Table 3:

| Type | Description |
|---|---|
| Single | iterates a single lane |
| BCast | broadcasts a single lane to a parallel group |
| Keep | keeps one lane out of a parallel group |
| DisjMrg | joins lanes of a layer |
| ConjMrg | intersects lanes of a layer |
| LockStep | co-iterates lanes of a layer |

Parallelization: is achieved by parallelizing loop iterations by using different lanes. Overall, parallelization allows (1) parallel loading, reducing the control overhead of traversing compressed data structures, and (2) parallel marshaling, enabling efficient vectorized compute in the host core. The bi-dimensional TMU design allows to parallelize loops at different levels. For instance, inner-loop parallelization allows to marshal adjacent tensor elements in the same vector operand (i.e. usual vectorization scheme). Outer-loop parallelization, instead, allows to marshal multiple fibers, slices, and arbitrary tensor dimensions in the same vector operand, enabling higher-dimensional parallelization schemes. In the SpMV example above, where we parallelize at the inner loop level, as shown in FIG. 6 we configure the first layer to load row pointers and BCast them to the next layer to load multiple elements of the same row in LockStep (with each lane loading at a different offset). To parallelize SpMV at the outer loop level, concurrently loading multiple rows into different lanes, both layers should work in LockStep. Both parallelization schemes aggregate data into vector operands that are marshaled into the core for computation. Boundary conditions can be handled by padding or marshaling the msk stream along with the operands, indicating the active elements in a multi-hot bit vector.

Fiber merging is achieved by loading different tensors in different lanes and merging them hierarchically with the mergers 36 placed between layers. Merging operations are implemented by “sorting” the fiber indexes of all the active lanes in the layers, which is achieved by iteratively pulling fibers with minimum indexes. The position of these fibers can be identified with a multi-hot l-bit predicate, which is pushed in the msk stream of the layer. These predicates are then used to aggregate vector operands to send to the core. In this way, for instance, we can implement Sp-KAdd, a summation of K sparse matrices, by mapping matrices in K different lanes and merging them with DisjMrg layers. The TMU traverses all the K matrices row by row and, for each row, sends to the core all non-zero values with the same index, which are reduced with a vector operation. If matrices are in CSR format, only the second compressed dimension requires merging. In contrast, if matrices are in DCSR format, both dimensions are compressed and both need to be merged. In this latter case, the merge happens hierarchically: only the active lanes from the first dimension, which are identified by the msk predicate of the first layer, are merged in the second layer.

Data marshaling and computation: Once we have mapped the loop structure of a tensor expression into TMU layers, the TMU streams the aggregated data to the core for computation. Core compute is enabled by wrapping into callback functions the compute code within the head (H), body (B), and tail (T) regions of traversal/merging loops. These callback functions have a unique callback ID and a list of scalar, vector, or predicate operands produced by the TMU. In the SpMV example above, we wrap the code in the inner-loop body into a ri callback, which multiplies and accumulates the matrix and vector values provided by the TMU, and the code in the inner-loop tail into a re callback, to store the accumulated results. Each layer of the TMU is programmed to trigger these callbacks upon traversal/merging events such as the begin, iteration, and end of a traversal or merging. In the SpMV example, we register the ri callback to completion of an individual iteration of the inner-loop layer and the re callback to the end of the inner-loop layer (completion of the iteration range). For the ri callback, we also register the list of operands consisting of matrix and vector values. Callback registration can be done with the following callback: add_callback(event, callback_id, args_list). It is also possible to assign a begin callback to be signalled before starting the iteration range, e.g. for clearing an accumulator value to zero. While running, the TMU pushes the callback IDs and vector operands of each registered event into the current outQ chunk. When the chunk is full, the core starts reading callback IDs and executes the proper HBT callback to compute the data operands. Meanwhile, the TMU populates another outQ chunk, overlapping data loading and computation.

An example of full TMU configuration code for the SpMV example is shown below:

1 //Load and broadcast CSR row pointers
2 row_fbrt = DnsFbrT(0, num_rows);
3 row_ptbs = row_fbrt.add_mem_str(a->ptrs);
4 row_ptes = row_fbrt.add_mem_str(a->ptrs+1);
5 row_grpt = BCast(row_fbrt);
6 //Load two row elements (and vec vals) in lockstep
7 //TUx1 have step=2, TU01 bas offset=0, TU11 has offset=1
8 col_fbrt0 = RngFbrT(row_ptbs, row_ptes, 0, 2);
9 col_idxs0 = col_fbrt0.add_mem_str(a->idxs);
10 nnz_vals0 = col_fbrt0.add_mem_str(a->vals);
11 vec_vals0 = col_fbrt0.add_mem_str(b, col_idxs0);
12 col_fbrt1 = RngFbrT(row_ptbs, row_ptes, 1, 2);
13 col_idxs1 = col_fbrt1.add_mem_str(a->idxs);
14 nnz_vals1 = col_fbrt1.add_mem_str(a->vals);
15 vec_vals1 = col_fbrt1.add_mem_str(b, col_idxs1);
16 col_grpt = LockStep(col_fbrt0, col_fbrt1);
17 nnz_vals = col_grpt.add_vec_str(nnz_vals0, nnz_vals1);
18 vec_vals = col_grpt.add_vec_str(vec_vals0, vec_vals1);
19 //Set the row-end and row-ite callbacks and operaods
20 col_grpt.add_callback(GITE, ri, {nnz_vals, vec_vals});
21 col_grpt.add_callback(GEND, re, { });

Lines 2-5 define the dense traversal (DnsFbrT) for the CSR matrix row pointers using TU₀₀ of the first layer as shown in FIG. 6. Lines 8-18 define the operations for the second layer The middle block (second layer) co-iterates in LockStep two columns in parallel (RngFbrT), marshaling vector operands to the core (lines 17 and 18). Lines 20 and 21 register the callbacks happening at each row iteration (ri), specifying the associated data, and at the end of a row (re). With the increasing adoption of Domain-Specific Languages (DSLs), TMU primitives and compute code can be generated by extending DSL compilers like Custard/SAM for TMU primitives and TACO for compute code. Alternatively, because of the advances in compiler analysis and transformation techniques for high-level synthesis, TMU primitives and compute code could be automatically generated out of standard high-level languages (e.g. C/C++).

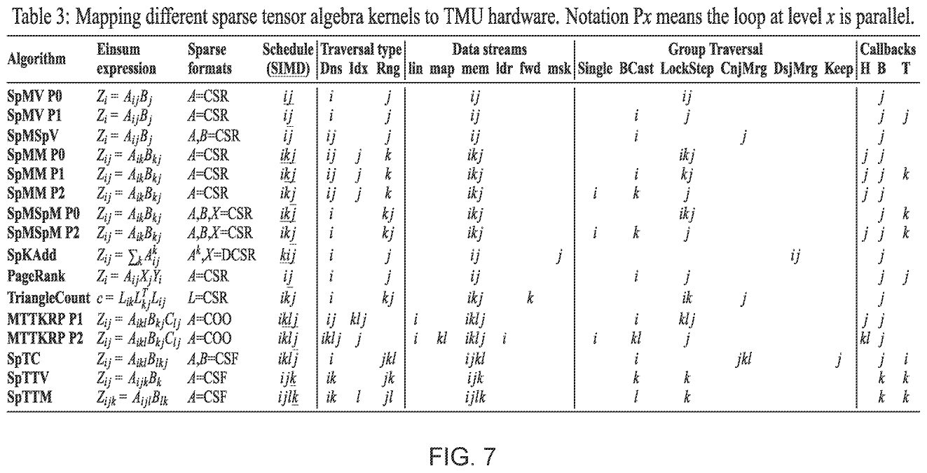

FIG. 7 shows an extensive list of tensor algebra algorithms showing how they map to the TMU. The loop schedule encodes the different parallelization schemes by underlining the parallel loops generating vector operands. Additionally, for each loop we state: (i) traversal type, (ii) instantiated data streams, (iii) layer operation mode, and (iv) associated callbacks (head, body or tail). To prove functional completeness of TMU primitives with respect to tensor algebra, we observe that our primitives implement all of the minimal functionalities for tensor algebra.

Further detail of an example of implementation and operation of TMU components is set out below.

Traversal Unit design: TUs implement the logic to (i) iterate tensor fibers, (ii) generate a binary control sequence to track the iteration status, and (iii) populate data streams. To iterate a tensor fiber, each TU implements a finite-state machine (FSM) looping through fbeg, fite, and fendstates. The fbeg state initializes the iteration boundaries, which can either be constant values or read from a leftward TU, stalling the current TU execution if the leftward TU has not produced new valid data yet. If the streams, which are implemented as circular queues, are not full, the fite state pushes (i) a 0 token into the binary control sequence, (ii) the current iteration index into the ite stream, and (iii) a new element into each other stream (which is generated according to the stream type). Finally, when the fiber traversal has no more elements to iterate, the fend state pushes a 1 token into the binary control sequence and goes back to the fbeg state.

All data streams within the same TU are of equal size and controlled simultaneously with a single push/pull command. Hence, the value of the i-th element of a queue is computed starting from the i-th element of its parent queue (e.g. the parent queue may be loading a stream of index values and the child queue loading another stream with offsets computed from the corresponding indexes in the parent queue).

Traversal Group design: A Traversal Group (TG) implements the logic to merge and co-iterate TUs in a layer. Similarly to TUs, TGs also implement an FSM to loop through gbeg, gite, and gendstates, generating predicates and a control sequence used later on to trigger callbacks. TG FSMs compute their control sequence by combining (i) the predicate of the previous layer, if any, and (ii) the control sequences of all the TUs in the layer, implementing a hierarchical evaluation. In particular, we consider a lane to be active only if the corresponding bit of the predicate coming out of the previous layer is set to true. TGs only process a gite state if all the active lanes have valid data in their queue heads.

In case of disjunctive merging, the gite state (i) computes the output predicate by setting to 1 the active lanes with minimum indexes, (ii) consumes them, and (iii) pushes a 0 token into the binary control sequence. When all active TUs have no more elements to merge disjunctively, the gend state pushes a 1 token into the binary control sequence.

In case of conjunctive merging, the gite state (i) computes the output predicate setting to one of the active lanes with minimum indexes, (ii) consumes them, and (iii) pushes a 0 token into the binary control sequence only if all active lanes have minimum indexes (all-true predicate). When any active TU has no more elements to merge conjunctively, the gend state pushes a 1 token into the binary control sequence.

Finally, in case of lockstep co-iteration, the gite state (i) computes the output predicate setting to one of the active lanes not done iterating, (ii) consumes their heads, and (iii) pushes a 0 token into the binary control sequence. When all active TUs have no more elements to co-iterate, the gend state pushes a 1 token into the binary control sequence.

Output Queue construction: The predicates and control sequences generated from each TG are then used to push callback IDs and operands into the outQ. Similarly to traversal and merging, outQ construction is implemented as an FSM running in each TG. However, while traversal and merging phases can be fully decoupled (i.e., each TU/TG iteration can start as soon as it has valid inputs), outQ generation needs to be serialized across TGs to preserve the order in which callbacks and operands are processed by the core. Hence, besides the obeg, oite, and oend states, outQ generation also uses ow4p and ow4n states to signal a TG is waiting for the previous or next TG to push data into the outQ. When a TG is in a gbeg, gite, or gend state, it checks whether there is any callback associated to that state and, if so, it pushes its ID and operands into the outQ buffer. For performance reasons, both the outQ and outQ buffers are double-buffered.

Memory arbiter: The TMU sends out memory requests at the cache line granularity. For each cycle, the TMU hierarchically selects the next cache line address to request. Requests from the leftmost layers (outer loops) are prioritized. TUs within the same layer are selected round-robin. Streams within a TU are selected in configuration order. Requests within the same queue are selected in order.

TU queue sizing: All TUs of a layer instantiate, at configuration time, the same amount of streams with the same size. However, since nested loops are mapped from left to right, the rightmost layers load and merge more data than the leftmost ones, leading to different storage requirements. To provide flexibility, all TUs within a lane share the same storage (e.g. in output queue buffer 42) and queues are allocated at configuration time using this shared per-lane storage. This permits shorter queues on upstream layers of TUs while making full utilization of the available storage, even if some TUs within a lane are not used at all. Queues are sized with an analytical model which allocates space to layers according to the amount of data to load, which can be statically estimated from the number of nnzs (non-zero values) per fiber of the tensor. For example, in the configuration example shown in FIG. 6, the active TUs are TU₀₀ in the first layer and TU₀₁, TU₁₁, TU₂₁, TU₃₁ in the second layer. To allow more efficient buffer utilisation TU₀₀ can make use of buffer space in output queue buffer 42 that is not in use by inactive TUs TU₁₀, TU₂₀, TU₃₀ in the first layer, and the active TUs in the second layer can make use of buffer space that would otherwise be allocated to unused TUs in the same lane of the inactive third and fourth layers. Also, the active TUs in the second layer may each be allocated greater buffer capacity in output queue buffer 42 than the active TU₀₀ in the first layer, recognising that TU₀₀ performing loads for the outer loop will load less data in total than TU₀₁, TU₁₁, TU₂₁, TU₃₁ performing loads for the inner loop, as each of TU₀₁, TU₁₁, TU₂₁, TU₃₁ will execute multiple iterations for each single iteration of the outer loop implemented by TU₀₀, and so performance can be improved by allocating more buffer capacity to TUs expected to load more data.

### System Integration:

Placement: Each core in a multicore system may feature a TMU 20. Alternatively, multiple cores could share use of a single TMU (on a time share basis). Also, it is not essential to provide every core in a multicore system with access to a TMU. The TMU traverses fibers by loading data from the LLC, and marshals the data into the output queue 48 that is written into the core's private L2 cache 14. Data from fiber traversals is unlikely to experience reuse from private caches, and by reading from the LLC we take advantage of the larger MSHR count (enabling more MLP). Each outQ 48 is core-private, therefore injecting it into the L2 cache enables faster compute throughput.

Memory subsystem integration: The TMU 20 operates with virtual addresses and uses the host core's address translation hardware (memory management unit, MMU). In particular, it queries a translation lookaside buffer (TLB) of the core, for example a level 2 TLB, and if a page fault occurs, the TMU 20 interrupts the core so the operating system running on the core 4 can handle the page fault. Once the missing translation is available, the MMU of the core 4 signals to the TMU 20 to indicate that the TMU 20 can retry the memory access.

The TMU 20 operates decoupled from the host core, issuing coherent read-only memory requests (fiber traversals) that do not affect coherence or consistency. TMU produces the outQ 48 that is written (write-only) into the private L2 cache of the host core. While the outQ data may be evicted into shared cache levels, this data is not shared across cores. Therefore, there is no shared read-write data between the TMU 4 and the host core or other cores in the system.

Context switching and exceptions: TMU architectural state is saved and restored when a thread is context-switched. When the operating system executing on the core 4 deschedules a thread that uses the TMU, it quiesces the TMU 20, saves its context, and restores it when the thread is rescheduled. The context state that is saved on a context switch comprises the initial TMU configuration (e.g., queue types and sizes, beg and end iteration boundaries defining the programmable iteration range for each TU), the head of each TU ite stream, and some control registers such as the base outQ address and current writing offset. Other information can also be captured in the saved context state. The memory-mapped outQ 48 is private per thread.

### Example Methods

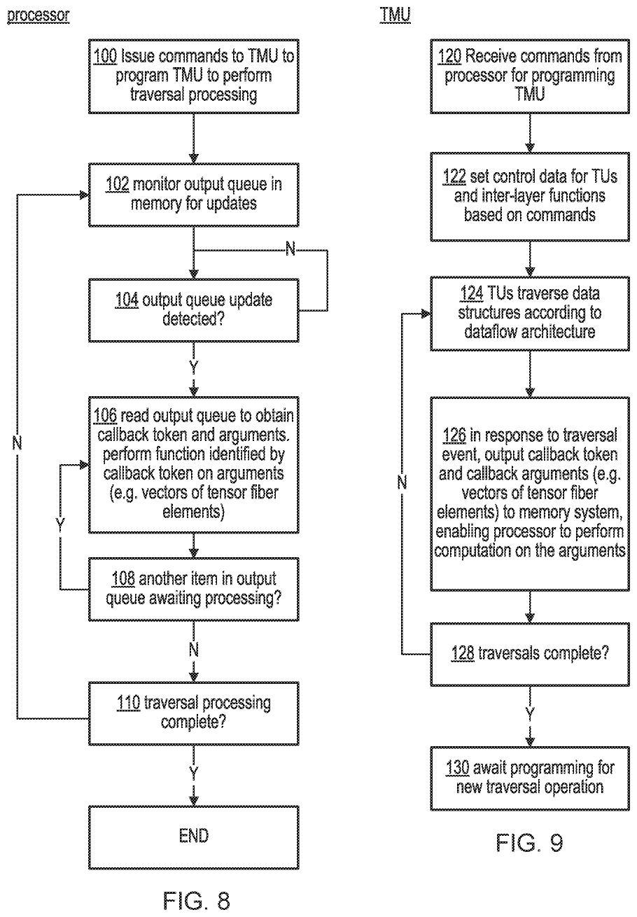

FIG. 8 is a flow diagram illustrating steps performed by a processor 4 for configuring the TMU 20 to carry out traversal processing for traversing data structures to identify operands for processing by the processor 4. The steps of FIG. 8 are carried out under software control, based on a sequence of program instructions executed by the processor 4. At step 100, the processor 4 issues commands to the TMU 20, to program the TMU 20 to perform traversal processing. For example, the configuration commands sent to the TMU 20 could include commands specifying, as a non-exhaustive list of examples:
TU configuration information specifying which layers/lanes of TUs are active, and identifying the required dataflow of elements to be provided between layers of TUs (e.g. whether the broadcast or single-lane iteration features are to be used);
address information identifying streams of elements to be loaded and/or the location of the output queue 48 in the address space;
iteration range defining data indicating the respective iteration ranges to be used for the active TUs 30;
any inter-layer function, such as merging, to be applied between layers; and
the traversal events for which the TUs are to generate callback tokens for signalling to the processor 4 that that the processor 4 is to carry out a corresponding callback function.

Having configured the TMU 20 to start traversal processing, at step 102 the processor 4 monitors the output queue 48 in the memory system for updates. This can be done in different ways. For example, the processor 4 could periodically poll the output queue 48 to check whether an update has occurred. Alternatively, a hardware-implemented memory monitoring technique can be used to set one or more addresses to be watched for updates, so that when the TMU 20 writes to one of the monitored addresses, this triggers a notification to the processor 4 (e.g. an interrupt). At step 104, the processor 4 waits until an update to the output queue 48 is detected.

Once an output queue update is detected, then at step 106 the processor 4 reads the output queue to obtain a callback token and one or more associated function arguments (e.g. the vector operands output by the TMU 20) that were written to the output queue 48 by the TMU 20. The processor 4 performs a function identified by the callback token on the function arguments, for example processing a vector of elements of tensor fibers using one of the callback functions mentioned earlier. At step 108 the processor 4 determines whether there is another item in the output queue awaiting processing and if so returns to step 106 to process that item. When there are no remaining items in the queue 48 awaiting processing, the processor 4 determines at step 110 whether traversal processing is complete, and if not returns to step 102 to continue monitoring the output queue 48 for updates. Once traversal processing is determined to be complete then the method ends.

FIG. 9 is a flow diagram illustrating steps performed by the TMU 20 to perform traversal processing. At step 120, the TMU 20 receives configuration commands from the processor 4 for programming the TMU 20. At step 122, the programming interface circuitry 44 of the TMU 20 sets control data for the TUs 30 and the inter-layer functions (mergers 36) based on the commands received at step 120. At step 124, the TUs 30 traverse data structures according to a dataflow architecture, to load elements from memory for one or more streams. At step 126, in response to detecting a traversal event (of a type configured using the TMU programming commands), a given TU 30 or group of TUs 30 outputs a callback token and corresponding callback arguments (e.g. a scalar element or vector of elements loaded in the traversal), which are written to the output buffer structure 48 in the memory system by the output buffer circuitry 42. At step 128, the TMU 20 determines whether the traversals configured for the various TUs 30 are all complete, and if not then traversal continues at step 124. Once all programmed traversals are complete then at step 130 the TMU 20 may enter quiescent state to await programming for a new traversal operation.

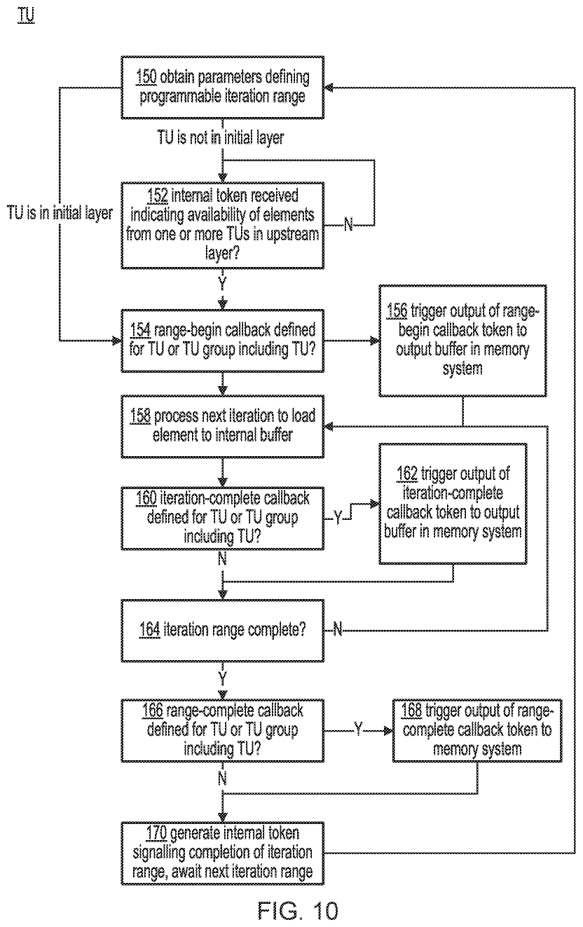

FIG. 10 illustrates in more detail steps performed by a given TU 30 of the TMU 20. At step 150, the TU 30 obtains parameters defining the programmable iteration range for the current traversal operation. These parameters could be obtained based on the configuration commands received from the processor 4 for programming the TMU 20 or could be derived from elements loaded by a TU 30 in an upstream layer 32 of TUs. If the given TU 30 is in a subsequent layer other than the initial layer 32 of the TMU 20, at step 152 the TU 30 awaits receipt of an internal token indicating availability of the elements from one or more TUs in an upstream layer that are to be processed by the given TU 30. If the given TU 30 is in the initial layer, step 152 can be omitted as there is no need to wait for availability of elements from an upstream layer 32.

Either way, at step 154, the given TU determines whether a range-begin callback event (e.g. the head (H) callback as mentioned earlier) has been defined, using the TMU configuration commands received from the processor 4, as one of the traversal events specified for the given TU 30 or a group of TUs 30 including the given TU. If so, then at step 156, the given TU 30 or the merger 36 associated with the group of TUs 30 outputs a range-begin callback token to the output buffer 48 stored in the memory system (depending on callback configuration, one or more callback function arguments derived from loaded data elements could also be output along with the range-begin callback token). For example, the range-begin callback can be used to trigger preliminary operations at the processor 4 such as clearing of an accumulator value.

At step 158, the given TU processes the next iteration from its programmable iteration range, to load, for each of one or more streams being processed by the given TU, a next element of that stream. The loaded elements are stored to the TMU's internal storage buffer, which has a buffer capacity dynamically partitioned between TUs 30 based on the expected volume of data to be loaded by each TU.

At step 160, the given TU 30 determines whether an iteration-complete callback event (e.g. the body (B) callback as mentioned earlier) was defined as one of the traversal events for the given TU 30 or a TU group including the given TU. If so, then at step 162, the given TU 30 or the merger 36 associated with the group of TUs 30 outputs an iteration-complete callback token which is output to the output buffer structure 48 in the memory system. Depending on callback configuration, one or more callback function arguments derived from loaded data elements could also be output along with the iteration-complete callback token. For example, the iteration-complete callback can be used to prompt the processor 4 to process an element loaded by the given TU or a vector of elements loaded by the TU group, e.g. by carrying out addition or multiply-accumulate operations on that element/vector of elements.

At step 164, the given TU 30 determines whether it has completed the final iteration for the programmable iteration range defined at step 150, and if not then the method returns to step 158 to process the next iteration.

Once the final iteration is complete, at step 166 the given TU 30 determines whether a range-complete callback event (e.g. the tail (T) callback as mentioned earlier) was defined as one of the traversal events for the given TU 30 or a TU group including the given TU 30. If so, then at step 168, the given TU 30 or the merger 36 associated with the group of TUs 30 outputs a range-complete callback token which is output to the output buffer structure 48 in the memory system. Depending on callback configuration, one or more callback function arguments derived from loaded data elements could also be output along with the range-complete callback token. The range-complete callback can, for example, be used to trigger operations at the processor 4 such as writeback to memory of the accumulator derived from the elements loaded in the preceding set of iterations.

At step 170, the given TU 30 generates an internal token signalling completion of its iteration range, which can be passed to any downstream layer 32 of TUs 30 to prompt those TUs to start their iterations for processing elements loaded by the given TU 30. The given TU 30 then awaits programming for handling another iteration range, and returns to step 150.

FIG. 11 is a flow diagram illustrating steps performed by the merger circuitry 36 to perform merging of streams loaded by respective TUs in the same layer. At step 200, the merger circuitry 36 compares elements at the head of respective first streams of data loaded by two or more TUs 30 in different lanes of a given layer 32 of the TMU 20. At step 202, the merger circuitry 36 identifies, among the elements at the head of each of the first streams, the element specifying the minimum index value. At step 204, the merger circuitry 36 generates merging predicates for each of the two or more TUs 30 in the given layer, indicating which of the first streams loaded by those TUs 30 contains an element at the head of the first stream which has the minimum index value. For example, the merging predicates may be set to 1 for each of the TUs 30 which has, at the head of its first stream, an element matching the minimum index value, and set to 0 for other TUs 30 having a different index value at its queue head for the first stream. At step 206, the merger circuitry 36 determines, based on the merging predicates, which elements of respective second streams of data loaded by the two or more TUs 30 of the given layer are to be processed in a given processing cycle by TUs 30 in a downstream layer 32. The method then returns to step 200 to perform the element comparison for a subsequent cycle based on the next set of elements of the first streams (which reach the head of the first streams being loaded once the current queue head elements have been processed).

FIG. 12 illustrates step showing a more detailed example for step 206 of FIG. 11. At step 210, the merger circuitry 36 determines, based on configuration data set based on the commands received from the processor 4 during programming of the TMU 20, which type of merging is required. If conjunctive merging has been defined for this inter-layer transition between layers 32 of TUs 30, then at step 212 the merger circuitry excludes from processing by a downstream layer 32 the elements of the respective second streams that are associated with a set of merging predicates indicating that at least one of the respective first streams loaded by the TU's in the preceding upstream layer 32 did not comprise any element specifying the corresponding index value. Hence, in cycles where the merging predicates contain any 0s (even if there are also some 1s), the corresponding set of elements of the second stream can be omitted from being passed downstream for processing by the downstream layer 32 of TUs 30. Applying this to the example of FIG. 3, for example, the first streams would be the respective index streams for fiber a and fiber b, and the second streams would be the respective value streams for fiber a and fiber b. The merging predicates corresponding to index 3 in Fiber a and index 1 in Fiber b would become 10 and 01 respectively as there is no instance of the index value 3 in Fiber b or index value 1 in Fiber a, and so applying conjunctive merging eliminates output of the value elements D, C in the second streams. The resulting stream of second elements output to the downstream TU layer 32 would comprise only elements B, A in fibers a and b corresponding to index value 0 and elements F, E in fibers a and b corresponding to index value 5, as for index values 0 and 5 the predicates would be 11 as both streams comprise an element corresponding to that index. Hence, the vectors of elements from the second streams that can be output to the output buffer 48 may be “B, A” and “F, E” respectively to allow the processor 4 to perform multiplications on those elements. There is no need to output vectors such as “D, 0” or “0, C” to the output buffer 48 because the values corresponding to index 1 and 3 were filtered out by the conjunctive merging—this improves performance because it means the processor 4 has fewer elements to perform, and in the case of multiplication of tensors anything multiplied by 0 would be 0 and so there is no need to output sets of elements that have a non-zero element at the corresponding index in any of the streams being loaded.

In contrast, if disjunctive merging has been defined for this inter-layer transition between layers 32 of TUs 30, then at step 214 of FIG. 12, the merger circuitry 36 enables processing by the downstream layer 32 of TUs 30 of elements of one or more of the respective second streams indicated by the merging predicates as corresponding to a given index value specified by an element in at least one of the respective first streams, even if another of the respective first streams did not comprise an element specifying that index value. At step 216, within any vector of elements of the respective second streams output corresponding to a given index value for the first streams, a padding value (e.g. zero) is output at the positions corresponding to one or more first streams which did not comprise any element specifying that given index value. For example, applying disjunctive merging to the example of FIG. 3, with the respective first streams comprising the index streams of fibers a and b and the respective second streams comprising the value streams of fibers a and b, the predicates in successive cycles would be “11” (indicating both fibers a and b contain an element corresponding to index value 0); “01” (indicating that fiber b contains an element corresponding to index value 1, but fiber a does not); “10” (indicating that fiber a contains an element corresponding to index value 3, but fiber b does not); and “11” (indicating both fibers contain an element corresponding to index value 5). The disjunctive merging results in the output vectors of elements in successive cycles becoming (B, A); (0, C); (D; 0) and (F; E) corresponding to index values 0, 1, 3, 5 respectively, with padding values of 0 being output at the positions corresponding to “0” predicates. Hence, the successive vectors of elements can be output to the output buffer 48 and processed by corresponding callback functions such that further elements of a merged tensor fiber are calculated by the processor 4 by adding the corresponding elements of each vector. Hence, disjunctive merging can be useful for marshalling loads of elements to be subject to addition because 0+X=X and so elements should still be output for a given index position if any one of the streams contains a non-zero element at that position, even if there are other streams with a zero element at that position.

Hence, by implementing such merging in the data element marshalling performed by the TMU 20, this reduces the number of comparisons needed to be performed by the processor for itself, which would tend to introduce inefficiency due to branch predictors mispredicting the data-dependent control flow based on those comparisons.

### Step-by-Step Examples

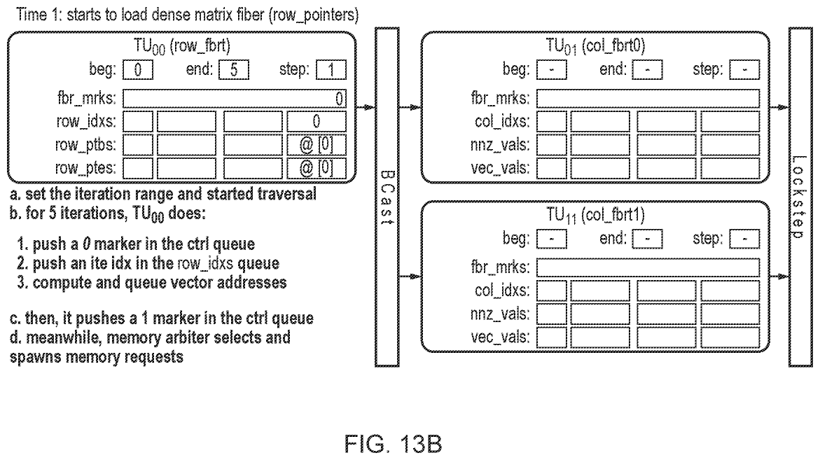

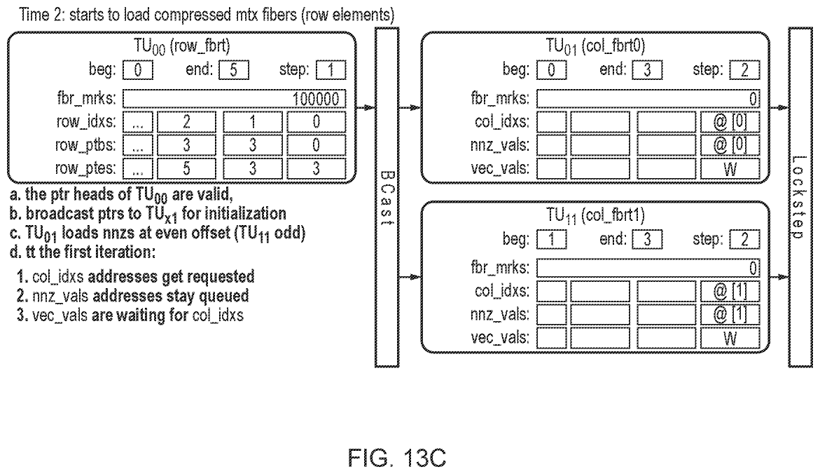

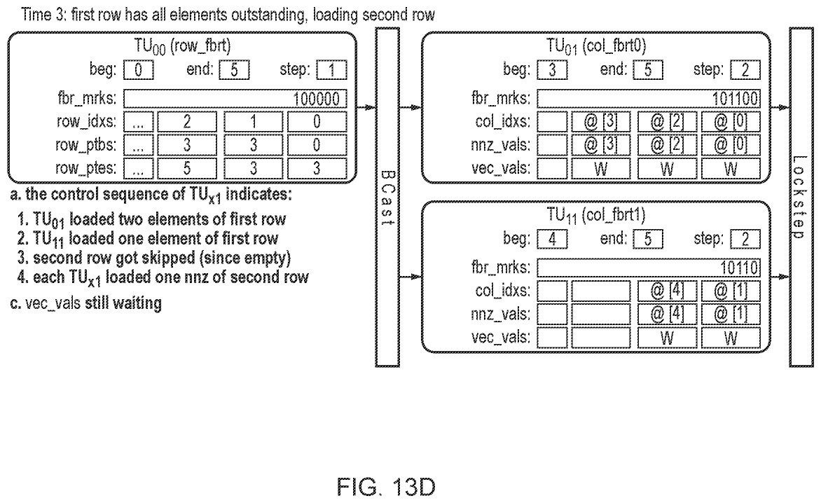

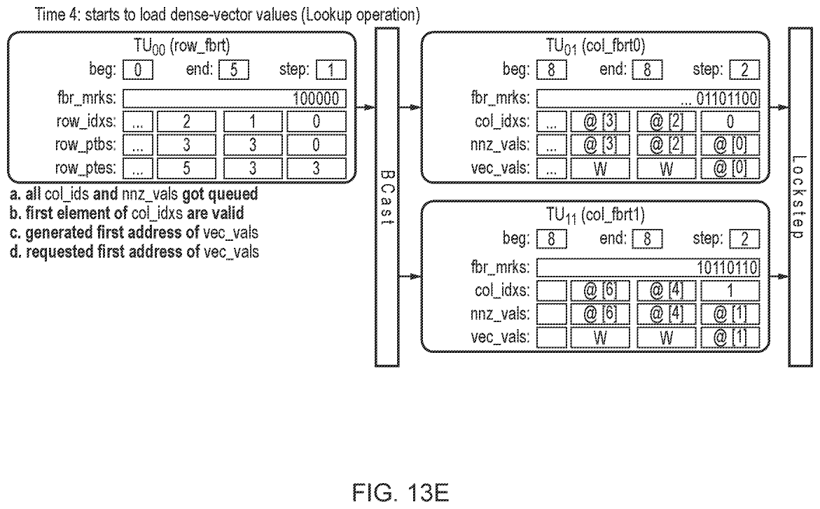

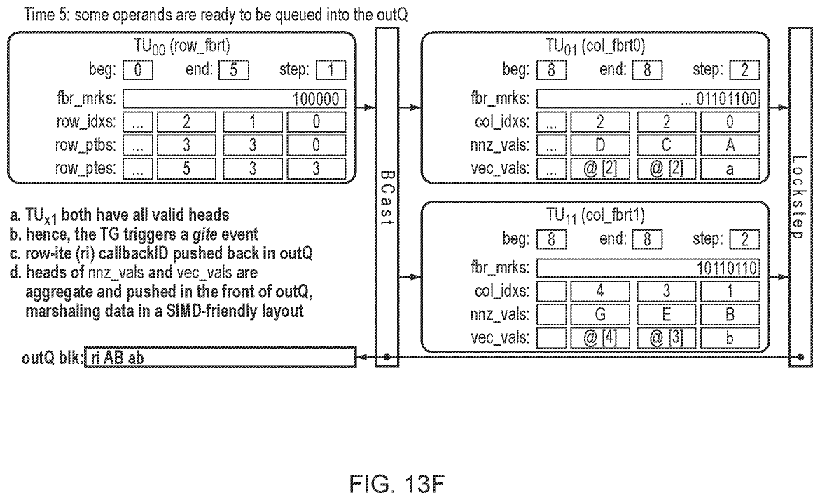

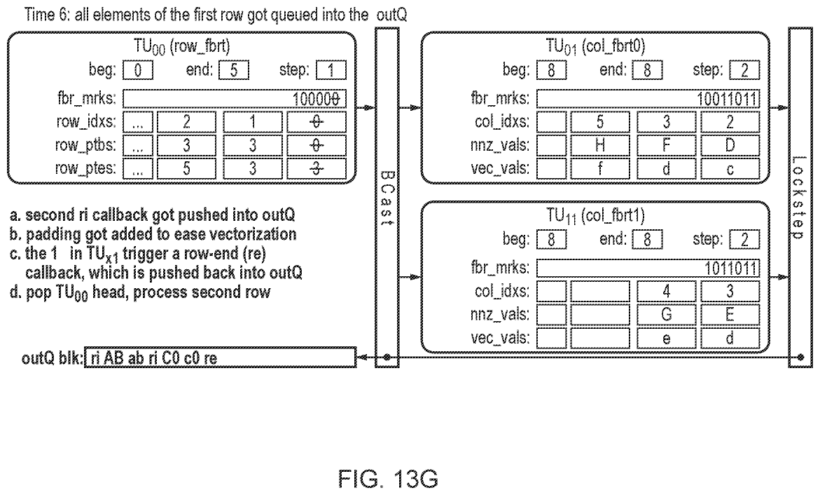

FIGS. 13A to 13G shows a step-by-step example for SpMV (see high-level code example above) where the TMU has been programmed using the TMU configuration code shown in the example above. As shown in FIG. 13A, the example loads the CSR matrix shown in part (b) of FIG. 2 and assumes a two-lane design for ease of explanation.

As shown in FIG. 13B, TU₀₀ in the first layer is configured to define an iteration range with beg=0, end=5 and step=1 (based on stepping through the 6 elements of the row_ptrs stream). TU₀₀ is configured to generate 3 streams: row_idxs which outputs the iteration count values for each iteration (i.e. a sequence 0, 1, 2, 3, 4, 5), row_ptbs which in iteration i loads the value of the row_ptrs structure at position i, and row_ptes which in iteration i loads the value of the row_ptrs structure at position+1. For each iteration, TU₀₀: pushes a 0 marker (internal token) into an internal control queue “fbr_marks” which is used to signal to a downstream layer when data is ready for processing, pushes the iteration index value into the “row_idxs” queue and computes the addresses from which the elements are to be loaded from the row_ptbs and row_ptes and issues load requests via the memory arbiter to request that the corresponding elements of the row_ptrs structure are loaded. The memory arbiter 40 selects load requests to be issued from memory and returns the loaded elements once received from the memory system (e.g. from shared cache 16). On completion of the final iteration, TU₀₀ pushes a “1” marker into the fbr_marks queue, which is an internal dataflow token signalling to the downstream layer that its TUs can start processing their iterations.

As shown in FIG. 13C, the merger 36 between layers 0 and 1 of the TMU 20 is set to a “broadcast” function so that, once TU₀₀ has valid data that has been returned from memory for the head of each of the row_ptbs, row_ptes streams, the pair of values “0, 3” at the heads of the respective row_ptbs, row_ptes streams is broadcast to TU₀₁ and TU₁₁ in the second layer. This pair of values “0, 3” represents that the next inner loop iteration of the iteration flow for the SpMV example is to iteratively fetch elements from the col_idxs and nnz_vals streams for positions 0, 1 and 2 (based on the rule for(p=ptr[i]; p<ptr[i+1]; p++) given for compressed fiber traversal above, when ptr[i] and ptr[i+1] are 0, 3 respectively, the iteration will iterate through p=0, p=1, p=2). In this example, TU₀₁ and TU₁₁ have been configured to operate in lockstep to load respective subsets of elements from the same streams col_idxs, nnz_vals, and so, while the “beg”, “end” parameters for TU₀₁ and TU₁₁ are both derived from the element values (0, 3) obtained from the head of the row_ptbs, row_ptes queues from TU₀₀, the “beg” parameter for TU₁₁ is offset by 1 from the beg parameter 0 for TU₀₁, and step parameters of 2 are set for both TU₀₁ and TU₁₁, so that in successive cycles TU₀₁ will perform loads for index positions 0 and 2 and TU₁₁ in lockstep will perform loads for index position 1 in the first cycle (and will run out of elements to load in the second cycle) allowing loading of the full set of 3 elements to be partially parallelized. In other words, for this two-lane example, TU₀₁ and TU₁₁ have been configured to load the col_indxs and nnz_vals at even and odd index positions respectively.

As shown in FIG. 13C, the TU₀₁ and TU₁₁ in the second layer can also be configured to load elements for a third stream “vec_vals” which represents a vector operand to be multiplied with the matrix represented in CSR format, but loading of elements of the vector has to wait until the column index values have been obtained for col_idxs, because the elements of the vector that are needed for the matrix*vector multiplication will depend on which columns of the matrix contain non-zero values as represented by the col_idxs structure. Hence, in FIG. 13C the vec_vals stream is not yet loaded as it is still waiting for the col_idxs values to become available.

As shown in FIG. 13D, as the respective sets of indexes from row_ptbs and row_ptes are propagated through to the second layer, this causes TU₀₁ and TU₁₁ to perform a series of sets of iterations, each set of iterations corresponding to a single row of the matrix structure stored in CSR format. Hence, for the first row 3 elements are loaded into each of the col_idxs and nnz_vals streams (2 by TU₀₁ and 1 by TU₁₁ as noted above for FIG. 13C), then the second row is skipped as it is empty (since row_ptrs[1]=row_ptrs[2]), then each of TU₀₁ and TU₁₁ loaded 1 element for the third row of the matrix. On completion of the set of iterations corresponding to a single row of the matrix (i.e. a single pair of row_ptbs, row_ptes stream values from TU₀₀), a “1” token is output in the control sequence “fbr_marks” for TU₀₁ and TU₁₁, while a “0” token is output on completion of an individual iteration within the set. In FIG. 13D the vec_vals stream is still waiting for the col_idxs stream to return data from memory following load requests being sent for each of the iterations.

As shown at FIG. 13E, once load data starts to be returned from memory for col_idxs, a corresponding address of the element of vec_vals to be multiplied by the nnz_vals element corresponding to the col_idx value can be generated, and a corresponding load request can be sent out via the memory arbiter 40.

As shown in FIG. 13F, once each of TU₀₁ and TU_{11 in the} lockstep TU group have valid elements at the queue heads for each of the col_idxs, nnz_vals, vec_vals streams (i.e. the load requests for the queue head positions have all returned data from memory), then the group of TUs can trigger the iteration-complete callback event, and pushes into the output queue 48 the callback event token (ri) and corresponding vector operands (“A, B”), (“a, b”) representing nnz_vals and vec_vals values that are to be multiplied together in the SpMV example.

As shown in FIG. 13G, as further load data gets returned, further callbacks are pushed out to the output buffer, and once the final set of iterations for a given row completes, the row end callback token “re” is issued.

Hence, for this example, for processing of the first row of the matrix, the sequence in the output buffer is:
ri, AB, ab, ri C0, c0, re.
   Here the 0s added as padding in the set of vector operands for the second ri callback indicate that there were insufficient elements in the row to fully populate the vectors in the last cycle. By outputting the elements as vector operands, this can speed up processing at the processor 4 compared to a scalar example. While FIGS. 13B-13G only comprise two lanes for ease of explanation, other examples may use a greater number of lanes to achieve greater speed up.

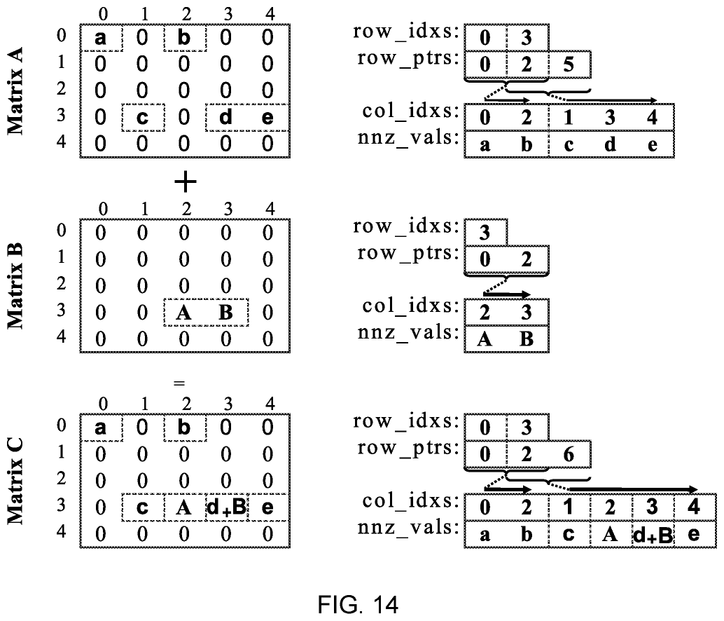

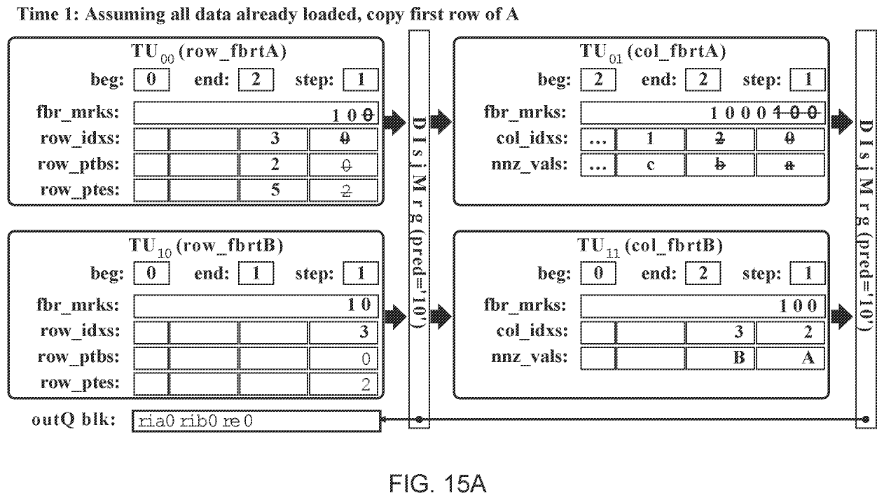

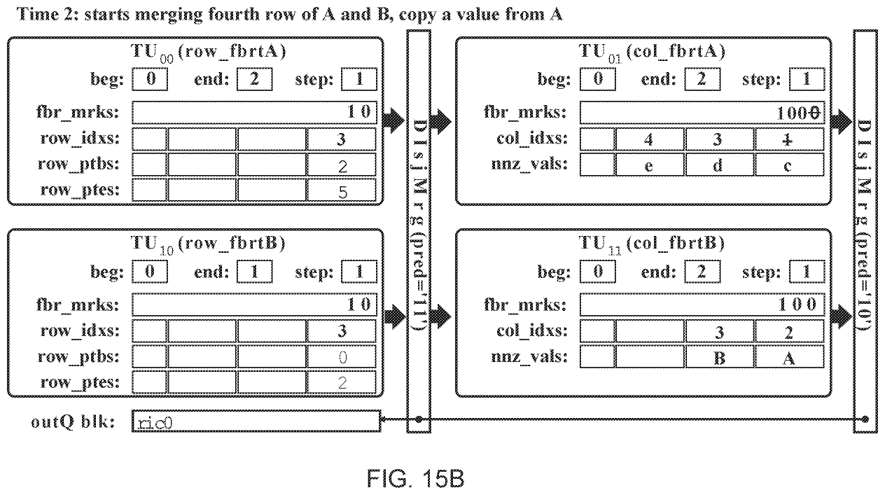

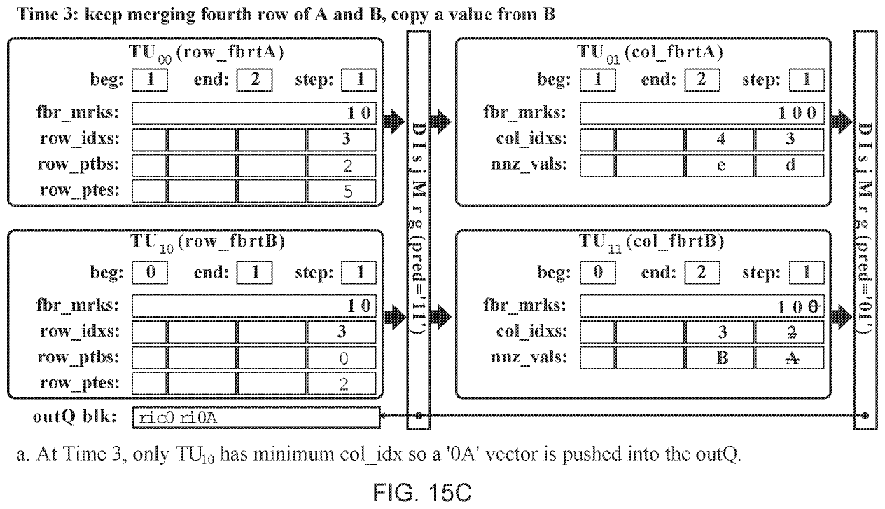

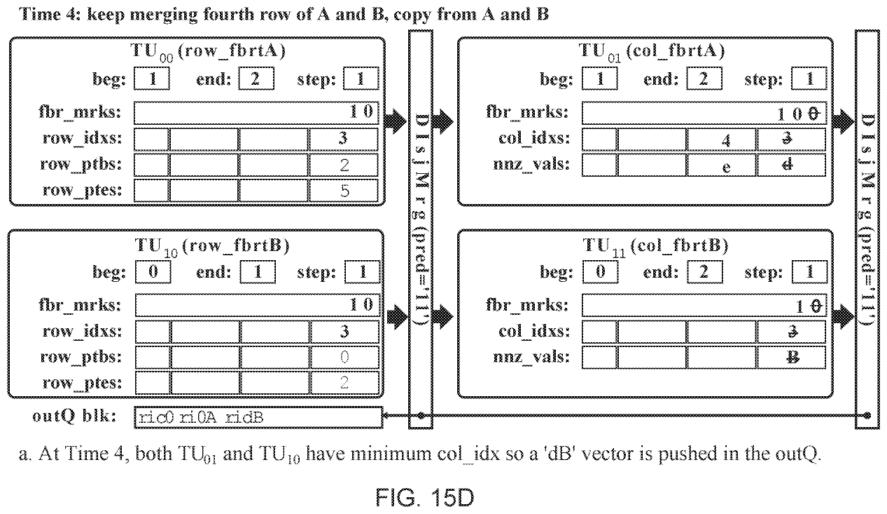

FIGS. 14 and 15A-15D shows a worked example of applying merging using the merging circuitry 36. As shown in FIG. 14, this example is based on a matrix addition operation to add two matrices A and B to produce a result matrix C. Hence, disjunctive merging is applied. In this example, the matrices are stored with DCSR format using the row_idxs structure to identify non-zero rows. In this example, rather than functioning to load respective subsets of elements from the same tensor fiber, the TUs TU₀₁ and TU₁₁ in layer 2 operate in lockstep in a single-lane mode where each of TU₀₁ and TU₁₁ are configured based on the elements loaded from the corresponding TU, TU₀₀ and TU₁₀ respectively, in the same lane of the previous layer.

FIG. 15A shows how TU₀₀ and TU₁₀ are configured to obtain the values of the corresponding row_ptbs, row_ptes streams corresponding to row_ptrs[i], row_ptrs[i+1] for the first row of matrix A (using TU₀₀) and matrix B (using TU₁₀). As shown in FIG. 15A, for the first iteration the loaded row index (row_idxs) for matrix A is 0 and the loaded row index for matrix B is 3, and so the minimum row index is 0, so a predicate of “10” is output to indicate that TU₀₀ has valid data to process in that cycle but TU₁₀ does not. If conjunctive merging had been applied, this cycle would be skipped for layer 2 as not all the TUs have valid data to process, but in this case as disjunctive merging is applied, the downstream layer does proceed to perform iterations based on the elements loaded by the upstream layer. Hence, among TU₀₁ and TU₁₁ in layer 2, the operation of TU₁₁ will be masked in the cycle when the row_ptbs/row_ptes values of (0, 2) are processed from TU₀₀, so that the eventual vector output for that cycle is ri a0 ri b0 re 0, with the 0s in a0 and b0 being padding that indicates that there were no elements of matrix b corresponding to the nnz_vals a, b loaded for row 0, and the final 0 after the re callback being the index of the row that was loaded (when processing a tensor in DCSR format, as the rows are compressed, it is useful to output the index of the row that was processed in association with the callback, as rows with no non-zero values may be missing).

Hence, in FIG. 15A:
a. As row_fbrtA has a lower row index than row_fbrtB, copy the whole row of A.
b. To do so, the first layer outputs a ‘10’ predicate which activates the first lane the second layer.
c. Hence, col_fbrtA iterates through all the row elements.
d. Meanwhile, these elements are vectorized (padding the second element with a zero value) and pushed into the output queue along with a row iteration “ri” callback ID.

As shown in FIG. 15B, in the cycles when row_idx 3 is being processed, both row_idx streams for TU₀₀ and TU₁₀ have the same value 3, and so this time the merging predicates are 11 as both TUs have valid elements for row_ptbs, row_ptes corresponding to that index value in the row_idx stream. That is, both matrices A and B have non-zero elements within row 3. Hence, both TU₀₁ and TU₁₁ in layer 2 are configured to be active in the next layer, to iterate through the respective iteration ranges controlled based on the row pointers identified by TU₀₀ and TU₁₀ in layer 1. However, for column index 1 only matrix A contains a non-zero element in row 3, so the merging predicate for layer 2 will indicate 10 to indicate that the output queue should be updated with a vector operand c0, where c is the value loaded for nnz_vals by TU₀₁ and the 0 is padding to indicate a masked element for nnz_vals in the masked TU₁₁.

Hence, in FIG. 15B:
a. As row_fbrtA and row_fbrtB have the same row index, merge the two rows.
b. To do so, the first layer outputs a ‘11’ predicate that activates both lanes of the second layer.
c. Hence, col_fbrtA and col_fbrtB both iterate through all the row elements.
d. At each iteration, the nnz_vals of the TUs that have minimum col_idx are vectorized and pushed into the output queue along with a “ri” callback ID.
e. At Time 2, only TU₀₁ has minimum col_idx so a ‘c0’ vector is pushed into the outQ.

FIGS. 15C and 15D show processing of subsequent cycles of loading elements for row 3 of the respective matrices A and B. Note that in FIG. 15D the predicate for layer 2 is 11 because both matrices A and B have a non-zero element in row 3 and column 3 (the comparison of the head of the col_idxs streams identified that both TUs had the same minimum column index of 3), while in FIG. 15C the minimum column index was 2 in TU₁₁ and so the predicate was 01 to indicate that TU₀₁ did not have valid nnz_vals for that minimum column index value of 2.

Hence, with this approach the stream of vectors allocated to the output queue 48 for row 3 is (c0, 0A, dB) which corresponds to the values of matrices A and B in row 3 at columns 1, 2 and 3 respectively. When these vectors are returned to the processor 4, the processor 4 may add the respective elements within each vector to obtain the resulting elements for matrix C which correspond to c, A, d+B respectively as shown in FIG. 14.

Hence, by implementing merging at the TMU, there is no need to implement the index comparison values in software at the processor 4, reducing the branch misprediction rate and hence improving performance.

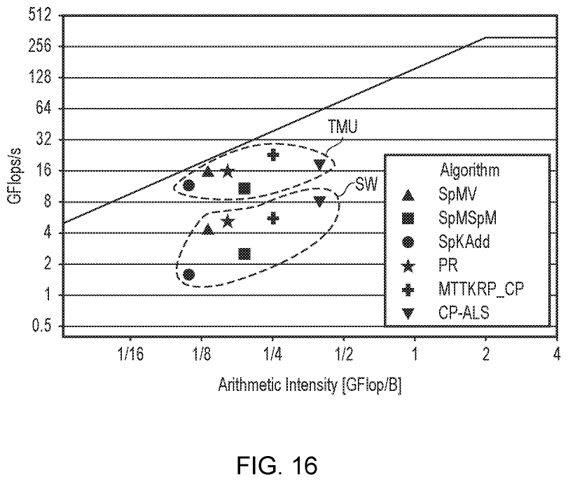

FIG. 16 is a roofline plot illustrating simulated performance speedup from simulating processing of various sparse tensor workloads on a standard CPU executing the benchmarks in software compared to a CPU 4 provided with the TMU to offload tensor traversal operations to the TMU 20. As shown in FIG. 16, on a gem5 simulated multicore system for HPC with 8 N1-like Arm cores and 4 HBM channels, an 8 KB-large TMU 20 achieves 3.5×, 3.3×, and 4.9× speedups over memory-intensive, compute-intensive, and merge-intensive vectorized software sparse tensor applications, respectively. With a 16 KB-large TMU, the same speedups go up to 3.8×, 3.4×, and 5.7×, respectively. On memory-intensive algorithms such as SpMV, the TMU saturates the memory bandwidth of such system (pulling 20 GB/S per core) whereas a pure software implementation on a general purpose CPU 4 can only achieve less than 10% of bandwidth utilization because of the limited instruction level parallelism and memory level parallelism of current general-purpose processors.

The examples above describe use cases for the TMU in handling sparse tensor algebra. As sparse tensor algebra kernels can be expressed as dataflow programs, we can decouple data loading and computation and accelerate data loading with the TMU. However, this does not hold for sparse/dense workloads such as recommender systems which do not have this dataflow structure. Deep Learning Recommendation Models (DLRMs), for instance, have a preliminary data gathering phase (embedding lookup) which reads and marshals scattered data from memory into a dense tensor which is then used in a second phase of dense non-dataflow computation (i.e. multilayer perceptrons). We can program the TMU to perform the data gathering phase and write into an output tensor in the private cache of the core without core intervention. This tensor is then used as input of the dense operators downstream. An advantage of this approach is that, as the TMU 20 writes directly to memory, the core can be used for other tasks. Conversely from the setting used for sparse tensor algebra, instead of using the callback mechanism to write vector operands and callback IDs into the output queue 48, we use the callbacks to write vector operands into some memory location (within the output tensor). In particular, these callbacks now take as input (1) a reference of a TMU stream that defines the vector operands and (2) a reference of a TMU stream that defines the addresses to write such vector operands in. Hence, it is not essential for the TMU to issue callbacks that prompt the processor core 4 to perform corresponding functions on the vector operands issued to the output queue 48. Instead, the TMU can also output its vector operands to addresses in memory determined based on one of the streams being loaded by the TMU 20. Hence, the TMU can be used for a wide range of use cases, not limited to sparse tensor algebra.

Concepts described herein may be embodied in a system comprising at least one packaged chip. The data structure marshalling unit described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

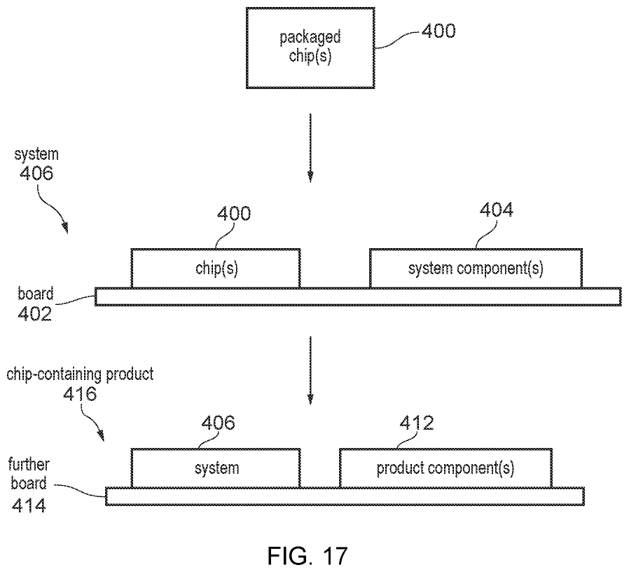

As shown in FIG. 17, one or more packaged chips 400, with the data structure marshalling unit described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the data structure marshalling unit described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. A data structure marshalling unit for a processor, the data structure marshalling unit comprising:
data structure traversal circuitry to perform data structure traversal processing according to a dataflow architecture;
   the data structure traversal circuitry comprising a plurality of layers of traversal circuit units, each layer comprising a plurality of lanes of traversal circuit units configured to operate in parallel;
   each traversal circuit unit configured to trigger loading, according to a programmable iteration range, of at least one stream of elements of at least one data structure from data storage circuitry;
   where for at least one programmable setting for the data structure traversal circuitry, the programmable iteration range for a given traversal circuit unit in a downstream layer is dependent on one or more elements of the at least one stream of elements loaded by at least one traversal circuit unit in an upstream layer of the data structure traversal circuitry; and
output interface circuitry to output to the data storage circuitry at least one vector of elements loaded by respective traversal circuit units in a given active layer of the data structure traversal circuitry.
   2. The data structure marshalling unit according to clause 1, in which the output interface circuitry is configured to output the at least one vector of elements to a private cache of the processor.
   3. The data structure marshalling unit according to any of clauses 1 and 2, in which each traversal circuit unit is configured to issue, to a shared cache shared by the processor and at least one further processor, load requests for loading the at least one stream of elements.
   4. The data structure marshalling unit according to any of clauses 1 to 3, in which, for said at least one programmable setting, the given traversal circuit unit in the downstream layer is configured to start performing iterations of the programmable iteration range in response to at least one internal token generated by at least one traversal circuit unit in the upstream layer indicating that one or more elements loaded by the at least one traversal circuit unit in the upstream layer are available after being loaded from the data storage circuitry.
   5. The data structure marshalling unit according to any of clauses 1 to 4, in which for at least one programmable setting for the output interface circuitry, the output interface circuitry is configured to output the at least one vector of elements loaded by the respective traversal circuit units to a location in the data storage circuitry corresponding to an address determined based on the at least one stream of elements loaded by one of the traversal circuit units of the data structure traversal circuitry.
   6. The data structure marshalling unit according to any of clauses 1 to 5, in which in at least one programmable setting, the data structure traversal circuitry is responsive to detection of at least one traversal event occurring for the given active layer of the data structure traversal circuitry to trigger output of at least one callback token to the data storage circuitry, each callback token comprising a callback function identifier indicative of a function to be performed by the processor on elements output to the data storage circuitry by the output interface circuitry.
   7. The data structure marshalling unit according to clause 6, in which the at least one traversal event comprises completion of an individual iteration of the programmable iteration range by one or more traversal circuit units of the given active layer.
   8. The data structure marshalling unit according to any of clauses 6 and 7, in which the at least one traversal event comprises start of a first iteration of the programmable iteration range by one or more traversal circuit units of the given active layer.
   9. The data structure marshalling unit according to any of clauses 6 to 8, in which the at least one traversal event comprises completion of a final iteration of the programmable iteration range by one or more traversal circuit units of the given active layer.
   10. The data structure marshalling unit according to any of clauses 1 to 9, in which, for at least one programmable setting of the data structure traversal circuitry, the programmable iteration range for each of a plurality of traversal circuit units in different lanes of the downstream layer is dependent on one or more elements of the at least one stream of elements loaded by a single traversal circuit unit in an upstream layer of the data structure traversal circuitry.
   11. The data structure marshalling unit according to any of clauses 1 to 10, in which for at least one programmable setting of the data structure traversal circuitry, a plurality of traversal circuit units in different lanes of the given active layer are configured to perform, in lockstep, iterations of respective programmable iteration ranges to load respective subsets of elements from the data storage circuitry, where for a given iteration, a given vector of the at least one vector of elements comprises one or more elements loaded by the plurality of traversal circuit units of the given active layer for the given iteration.
   12. The data structure marshalling unit according to any of clauses 1 to 11, comprising merging circuitry to:
compare elements of respective first streams loaded by two or more traversal circuit units in different lanes of a given layer of the data structure traversal circuitry, to determine one or more sets of merging predicates, each set of merging predicates corresponding to a respective index value specified by an element loaded for at least one of the respective first streams, and indicating which of the two or more respective first streams include an element having that given index value; and
determine, based on the one or more sets of merging predicates, which elements of respective second streams loaded by the two or more traversal circuit units of the given layer are to be processed in a given processing cycle by a downstream layer of the data structure traversal circuitry or the output interface circuitry.
   13. The data structure marshalling unit according to clause 12, in which for at least one programmable setting for the merging circuitry, the merging circuitry is configured to exclude, from processing by the downstream layer or the output interface circuitry, elements of the respective second streams associated with a set of merging predicates indicating that at least one of the respective first streams did not comprise any element specifying the index value corresponding to that set of merging predicates, even if there is at least one of the respective first streams that did comprise an element specifying that index value.
   14. The data structure marshalling unit according to any of clauses 12 and 13, in which for at least one programmable setting for the merging circuitry, the merging circuitry is configured to enable processing, by the downstream layer or the output interface circuitry, of elements of one or more of the respective second streams indicated by a corresponding set of merging predicates as corresponding to a given index value specified by an element in at least one of the respective first streams.
   15. The data structure marshalling unit according to any of clauses 1 to 14, comprising arbitration circuitry to arbitrate between load requests issued by the respective traversal circuit units, to select load requests for issue to the data storage circuitry;
wherein the arbitration circuitry is configured to apply an arbitration policy in which, in the event of contention for load request bandwidth between load requests issued by traversal circuit units in different layers of the data structure traversal circuitry, load requests issued by traversal circuit units in an upstream layer of the data structure traversal circuitry have a greater probability of being selected than load requests issued by traversal circuit units in a downstream layer of the data structure traversal circuitry.
   16. The data structure marshalling unit according to any of clauses 1 to 15, comprising an internal buffer to buffer values obtained in data structure traversal processing performed by the traversal circuit units; in which
the internal buffer is dynamically partitionable to allocate variable amounts of buffer capacity to different traversal circuit units depending on a programmable setting selected for the data structure traversal circuitry.
   17. The data structure marshalling unit according to any of clauses 1 to 16, in which the data structure traversal circuitry is configured to support loading of elements from a sparse tensor data structure.
   18. The data structure marshalling unit according to any of clauses 1 to 17, in which the data structure traversal circuitry is configured to support loading of elements of tensor fibers according to one or more sparse tensor formats.
   19. An apparatus comprising:
the data structure marshalling unit according to any of clauses 1 to 18; and
the processor.
   20. A system comprising:
the data structure marshalling unit of any of clauses 1 to 19, implemented in at least one packaged chip;
at least one system component; and a board,
wherein the at least one packaged chip and the at least one system component are assembled on the board.
   21. A chip-containing product comprising the system of clause 20 assembled on a further board with at least one other product component.
   22. A non-transitory computer-readable medium to store computer-readable code for fabrication of a data structure marshalling unit for a processor, the data structure marshalling unit comprising:
data structure traversal circuitry to perform data structure traversal processing according to a dataflow architecture;
   the data structure traversal circuitry comprising a plurality of layers of traversal circuit units, each layer comprising a plurality of lanes of traversal circuit units configured to operate in parallel;
   each traversal circuit unit configured to trigger loading, according to a programmable iteration range, of at least one stream of elements of at least one data structure fiber from data storage circuitry;
   where for at least one programmable setting for the data structure traversal circuitry, the programmable iteration range for a given traversal circuit unit in a downstream layer is dependent on one or more elements of the at least one stream of elements loaded by a traversal circuit unit in an upstream layer of the data structure traversal circuitry; and
output interface circuitry to output to the data storage circuitry at least one vector of elements loaded by respective traversal circuit units in a given active layer of the data structure traversal circuitry.
   23. A method comprising:
performing data structure traversal processing using data structure traversal circuitry of a data structure marshalling unit for a processor, the data structure traversal circuitry performing the data structure traversal processing according to a dataflow architecture;
   the data structure traversal circuitry comprising a plurality of layers of traversal circuit units, each layer comprising a plurality of lanes of traversal circuit units configured to operate in parallel;
   each traversal circuit unit configured to trigger loading, according to a programmable iteration range, of at least one stream of elements of at least one data structure fiber from data storage circuitry;
   where for at least one programmable setting for the data structure traversal circuitry, the programmable iteration range for a given traversal circuit unit in a downstream layer is dependent on one or more elements of the at least one stream of elements loaded by a traversal circuit unit in an upstream layer of the data structure traversal circuitry; and
outputting to the data storage circuitry at least one vector of elements loaded by respective traversal circuit units in a given active layer of the data structure traversal circuitry.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A data structure marshalling unit for a processor, the data structure marshalling unit comprising:
data structure traversal circuitry to perform data structure traversal processing according to a dataflow architecture;
the data structure traversal circuitry comprising a plurality of layers of traversal circuit units, each layer comprising a plurality of lanes of traversal circuit units configured to operate in parallel;
each traversal circuit unit configured to trigger loading, according to a programmable iteration range, of at least one stream of elements of at least one data structure from data storage circuitry;
where for at least one programmable setting for the data structure traversal circuitry, the programmable iteration range for a given traversal circuit unit in a downstream layer is dependent on one or more elements of the at least one stream of elements loaded by at least one traversal circuit unit in an upstream layer of the data structure traversal circuitry; and
output interface circuitry to output to the data storage circuitry at least one vector of elements loaded by respective traversal circuit units in a given active layer of the data structure traversal circuitry.

2. The data structure marshalling unit according to claim 1, in which the output interface circuitry is configured to output the at least one vector of elements to a private cache of the processor.

3. The data structure marshalling unit according to claim 1, in which each traversal circuit unit is configured to issue, to a shared cache shared by the processor and at least one further processor, load requests for loading the at least one stream of elements.

4. The data structure marshalling unit according to claim 1, in which, for said at least one programmable setting, the given traversal circuit unit in the downstream layer is configured to start performing iterations of the programmable iteration range in response to at least one internal token generated by at least one traversal circuit unit in the upstream layer indicating that one or more elements loaded by the at least one traversal circuit unit in the upstream layer are available after being loaded from the data storage circuitry.

5. The data structure marshalling unit according to claim 1, in which in at least one programmable setting, the data structure traversal circuitry is responsive to detection of at least one traversal event occurring for the given active layer of the data structure traversal circuitry to trigger output of at least one callback token to the data storage circuitry, each callback token comprising a callback function identifier indicative of a function to be performed by the processor on elements output to the data storage circuitry by the output interface circuitry.

6. The data structure marshalling unit according to claim 5, in which the at least one traversal event comprises completion of an individual iteration of the programmable iteration range by one or more traversal circuit units of the given active layer.

7. The data structure marshalling unit according to claim 5, in which the at least one traversal event comprises start of a first iteration of the programmable iteration range by one or more traversal circuit units of the given active layer.

8. The data structure marshalling unit according to claim 5, in which the at least one traversal event comprises completion of a final iteration of the programmable iteration range by one or more traversal circuit units of the given active layer.

9. The data structure marshalling unit according to claim 1, in which, for at least one programmable setting of the data structure traversal circuitry, the programmable iteration range for each of a plurality of traversal circuit units in different lanes of the downstream layer is dependent on one or more elements of the at least one stream of elements loaded by a single traversal circuit unit in an upstream layer of the data structure traversal circuitry.

10. The data structure marshalling unit according to claim 1, in which for at least one programmable setting of the data structure traversal circuitry, a plurality of traversal circuit units in different lanes of the given active layer are configured to perform, in lockstep, iterations of respective programmable iteration ranges to load respective subsets of elements from the data storage circuitry, where for a given iteration, a given vector of the at least one vector of elements comprises one or more elements loaded by the plurality of traversal circuit units of the given active layer for the given iteration.

11. The data structure marshalling unit according to claim 1, comprising merging circuitry to:
compare elements of respective first streams loaded by two or more traversal circuit units in different lanes of a given layer of the data structure traversal circuitry, to determine one or more sets of merging predicates, each set of merging predicates corresponding to a respective index value specified by an element loaded for at least one of the respective first streams, and indicating which of the two or more respective first streams include an element having that given index value; and
determine, based on the one or more sets of merging predicates, which elements of respective second streams loaded by the two or more traversal circuit units of the given layer are to be processed in a given processing cycle by a downstream layer of the data structure traversal circuitry or the output interface circuitry.

12. The data structure marshalling unit according to claim 11, in which for at least one programmable setting for the merging circuitry, the merging circuitry is configured to exclude, from processing by the downstream layer or the output interface circuitry, elements of the respective second streams associated with a set of merging predicates indicating that at least one of the respective first streams did not comprise any element specifying the index value corresponding to that set of merging predicates, even if there is at least one of the respective first streams that did comprise an element specifying that index value.

13. The data structure marshalling unit according to claim 11, in which for at least one programmable setting for the merging circuitry, the merging circuitry is configured to enable processing, by the downstream layer or the output interface circuitry, of elements of one or more of the respective second streams indicated by a corresponding set of merging predicates as corresponding to a given index value specified by an element in at least one of the respective first streams.

14. The data structure marshalling unit according to claim 1, comprising arbitration circuitry to arbitrate between load requests issued by the respective traversal circuit units, to select load requests for issue to the data storage circuitry;
wherein the arbitration circuitry is configured to apply an arbitration policy in which, in the event of contention for load request bandwidth between load requests issued by traversal circuit units in different layers of the data structure traversal circuitry, load requests issued by traversal circuit units in an upstream layer of the data structure traversal circuitry have a greater probability of being selected than load requests issued by traversal circuit units in a downstream layer of the data structure traversal circuitry.

15. The data structure marshalling unit according to claim 1, comprising an internal buffer to buffer values obtained in data structure traversal processing performed by the traversal circuit units; in which
the internal buffer is dynamically partitionable to allocate variable amounts of buffer capacity to different traversal circuit units depending on a programmable setting selected for the data structure traversal circuitry.

16. An apparatus comprising:
the data structure marshalling unit according to claim 1; and
the processor.

17. A system comprising:
the data structure marshalling unit of claim 1, implemented in at least one packaged chip;
at least one system component; and
a board,
wherein the at least one packaged chip and the at least one system component are assembled on the board.

18. A chip-containing product comprising the system of claim 17 assembled on a further board with at least one other product component.

19. A non-transitory computer-readable medium to store computer-readable code for fabrication of a data structure marshalling unit for a processor, the data structure marshalling unit comprising:
data structure traversal circuitry to perform data structure traversal processing according to a dataflow architecture;
the data structure traversal circuitry comprising a plurality of layers of traversal circuit units, each layer comprising a plurality of lanes of traversal circuit units configured to operate in parallel;
each traversal circuit unit configured to trigger loading, according to a programmable iteration range, of at least one stream of elements of at least one data structure fiber from data storage circuitry;
where for at least one programmable setting for the data structure traversal circuitry, the programmable iteration range for a given traversal circuit unit in a downstream layer is dependent on one or more elements of the at least one stream of elements loaded by a traversal circuit unit in an upstream layer of the data structure traversal circuitry; and
output interface circuitry to output to the data storage circuitry at least one vector of elements loaded by respective traversal circuit units in a given active layer of the data structure traversal circuitry.

20. A method comprising:
performing data structure traversal processing using data structure traversal circuitry of a data structure marshalling unit for a processor, the data structure traversal circuitry performing the data structure traversal processing according to a dataflow architecture;
the data structure traversal circuitry comprising a plurality of layers of traversal circuit units, each layer comprising a plurality of lanes of traversal circuit units configured to operate in parallel;
each traversal circuit unit configured to trigger loading, according to a programmable iteration range, of at least one stream of elements of at least one data structure fiber from data storage circuitry;
where for at least one programmable setting for the data structure traversal circuitry, the programmable iteration range for a given traversal circuit unit in a downstream layer is dependent on one or more elements of the at least one stream of elements loaded by a traversal circuit unit in an upstream layer of the data structure traversal circuitry; and
outputting to the data storage circuitry at least one vector of elements loaded by respective traversal circuit units in a given active layer of the data structure traversal circuitry.
